(19) United States
(12) Patent Application Publication
(10) Pub. No.: US 2009/0028767 A1
(43) Pub. Date: Jan. 29, 2009

(54) Waste Treatment and Energy Production Utilizing Halogenation Processes

(76) Inventors: Melahn L. Parker, Miami, FL (US); Robin Z. Parker, Miami, FL (US)

Correspondence Address: WILSON SONSINI GOODRICH & ROSATI, 650 PAGE MILL ROAD, PALO ALTO, CA, 94304-1050, US

(21) Appl. No.: 12/174,608

(22) Filed: Jul. 16, 2008

Related U.S. Application Data
(60) Provisional application No. 60/949,994, filed on Jul. 16, 2007.

(51) Int. Cl. B01D 53/00; C01B 7/00; C01B 7/09; C01B 31/20; B01D 53/48; C25B 1/24; B01J 19/00

(52) U.S. Cl. 423/235; 423/507; 423/437.1; 423/242.1; 205/618; 205/619; 423/210; 422/189; 422/193

(57) ABSTRACT

A method for generating energy and/or fuel from the halogenation of a carbon-containing material and/or a sulfur-containing chemical comprises supplying the carbon-containing material (e.g., coal, lignite, biomass, cellulose, milorganite, methane, sewage, animal manure, municipal solid waste, pulp, paper products, food waste) and/or the sulfur-containing chemical (e.g., H₂S, SO₂, SO₃, elemental sulfur) and a first halogen-containing chemical to a reactor. The carbon-containing material and/or the sulfur-containing chemical and the halogen-containing chemical are reacted in the reactor to form a second halogen-containing chemical and carbon dioxide, sulfur and/or sulfuric acid. The second halogen-containing chemical is dissociated (e.g., electrolyzed) to form the first halogen-containing chemical and hydrogen gas (H₂). The first halogen-containing chemical can be Br₂ and the second halogen-containing chemical can be HBr. Any carbon dioxide formed during reaction can be directed to a prime mover (e.g., turbine) to generate electricity. Any ash and/or sulfur formed can be removed. In some cases a sulfur-containing chemical can be supplied to the reactor with the carbon-containing material.

This application claims the benefit of priority to U.S. Provisional Application No. 60/949,994, filed Jul. 16, 2007 and entitled “WASTE TREATMENT AND ENERGY PRODUCTION UTILIZATION HALOGENATION PROCESSES,” which is entirely incorporated by reference herein.

### FIELD OF THE INVENTION

This invention relates generally to utilizing halogen-containing compounds for energy production. More specifically, the invention relates to utilizing bromine-containing compounds in systems for energy generation, energy storage, hydrogen production, pollutant capture and removal, and waste treatment.

### BACKGROUND OF THE INVENTION

Research in halogenation (e.g., bromination) processes are motivated by the need to produce fuels from biomass, advances in hydrogen bromide electrolysis, the continued rise of gas and oil prices, growing need for energy storage to encourage adoption of renewable energy and increased concern over regulated and unregulated pollutants. Prior work is described regarding bromination of carbonaceous material, the capture and conversion of regulated and unregulated pollutants, hydrogen production, electrical energy storage and the production of liquid fuels.

Reserves of oil and natural gas are rapidly being depleted, causing economic hardship, while growing concern for carbon dioxide and other greenhouse gas emissions are prompting the adoption of carbon-neutral technologies for energy needs. Hydrogen (H₂) can potentially serve as fuel for the world's energy requirements if it could be manufactured economically and in an environmentally friendly manner. Hydrogen has a variety of uses, such as, for example, hydrocracking, upgrading, and removing sulfur from crude oil in refineries, the production of ammonia for fertilizer, and for use in explosives, food processing, welding, and semiconductors. A hydrogen economy would use hydrogen as a fuel and chemical feedstock, thus reducing the world's dependence on oil and natural gas (methane, CH₄).

The principal source of hydrogen in the United States is steam-hydrocarbon reforming, which uses a fossil fuel to create hydrogen and carbon monoxide, which is then oxidized by steam (H₂O) to yield carbon dioxide and more hydrogen. This process is complex and requires catalysts. Additionally, due to the requirement for high operating temperatures and pressures, expensive equipment is required for steam-hydrocarbon reforming. Furthermore the hydrogen-rich product gas stream requires additional steps to purify the hydrogen and remove contaminants, such as sulfur species, adding to processing costs. An alternative to steam-hydrocarbon reforming is the electrolysis of water to produce hydrogen: 2H₂O→2H₂+O₂. The theoretical decomposition voltage (half cell potential) of water is 1.23 volts (V), but in actual practice, the half-cell potential for water is 1.7 volts, while at typical operating current densities over 2 volts are required. Water must be purified before electrolysis and direct current (DC) must be used for the electrolytic process. Because electricity is typically available in the form of alternating current (AC), an ac-to-dc converter is required, which leads to increased processing costs and energy losses. These factors contribute to making water electrolysis more expensive (and impractical) than steam-hydrocarbon reforming.

### Bromination of Carbonaceous Material

The combustion of carbonaceous matter with bromine and water to form hydrogen bromide (HBr) and carbon dioxide (CO₂) is exothermic, releasing a large amount of energy (heat), which may be used to generate steam (or another working fluid) for the production of electricity. Hydrogen bromide (HBr) may be electrolyzed or reacted with a metal bed to produce hydrogen. High pressure carbon dioxide formed during combustion with bromine (Br₂) or another halogen-containing chemical and water may be expanded through a turbine to produce electricity, or combined with hydrogen to make methanol, ethanol, or other liquid fuels.

The combustion of carbonaceous matter with oxygen has been exploited for centuries, and some well-known material heat of combustion, specific reactions and reaction enthalpies are as follows:

Cellulose(Wood)Oxidation: Δ_{c}H=6,900Btu/lb (1)

C₆H₁₀O₅(s)+7O₂(g)→5H₂O(g)+7CO₂(g) ΔH°=−2,610kJ/mol (2)

Coal(Lignite-Bituminous)Oxidation: Δ_{c}H=8-13,500Btu/lb (3)

C₁₃₅H₉₆O₉NS+157½O₂→48H₂O+135CO₂+SO₂+NO₂ (4)

Carbon(Charcoal)Oxidation: Δ_{c}H=14,100Btu/lb (5)

C(s)+O₂(g)→CO₂(g) ΔH°=−394kJ/mol (6)

Methane Oxidation: Δ_{c}H=21,600Btu/lb (7)

CH₄(g)+2O₂(g)→CO₂(g)+2H₂O(g) ΔH°=−802kJ/mol (8)

Hydrogen is produced through the partial oxidation of carbon (and other hydrocarbons) to carbon monoxide followed by its reaction with steam:

C(s)+½O₂(g)→CO(g) ΔH°=−111kJ/mol; Δ_{c}H=4,000Btu/lb (9)

CO(g)+H₂O(g)→H₂(g)+CO₂(g) ΔH°=−41kJ/mol; Δ_{c}H=630Btu/lb (10)

It has been proposed that large quantities of hydrogen can be produced from electrolysis of water:

H₂O(l)→H₂(g)+½O₂(g) ΔH°=286kJ/mol (11)

Similar to oxidation, the bromination of carbonaceous material with water as a co-reactant is an exothermic reaction, creating an opportunity to convert the released energy into work. These reactions can produce high temperature and high pressure CO₂, which may be expanded through a turbine to produce additional work, and hydrogen bromide (HBr), which may be dissociated through a variety of processes to recover bromine for recycling and hydrogen production. The hydrogen-bromine bond of HBr is considerably weaker than the highly stable hydrogen-oxygen bonds of water. The exothermic nature of the reactions reduces the energy requirements for the production of hydrogen to only that required for electrolytic, catalytic, or thermal dissociation of hydrogen bromide. Several sample bromination reactions are shown in the equations below (‘az’ designates a 47.5 wt % HBr solution):

Cellulose Bromination:yields 2moles H₂ per mole Carbon Δ_{c}H=5,400Btu/lb (12)

C₆H₁₀O₅(s)+7H₂O(l)+12Br₂(l)→24HBr(az)+6CO₂(g) ΔH°=−2038kJ/mol (13)

Coal Bromination:yields 2.3moles H₂ per mole Carbon Δ_{c}H=6-10,500Btu/lb (14)

C₁₃₅H₉₆O₉NS+265H₂O+312Br₂→624HBr+135CO₂+H₂SO₄+ 1/2N₂ (15)

Carbon(charcoal)Bromination:yields 2moles H₂ per mole C Δ_{c}H=11,000Btu/lb (16)

C(s)+2H₂O(l)+2Br₂(l)→4HBr(az)+CO₂(g) ΔH°=−308kJ/mol (17)

The bromination of carbonaceous compounds with water to produce hydrogen bromide and carbon dioxide has been demonstrated by several groups. Table 1 summarizes these results.

TABLE 1

| Date | Group | Species | Demo Size | | Temp | Reaction Time | | Avg. HBr yield |
|---|---|---|---|---|---|---|---|---|
| 1926 | German | Carbon | Unknown | | 500° C. | unknown | | 100% |
| 1927 | Russian | Carbon | 6-8 | gram | 500° C. | 0.1 | seconds | 100% |
| 1977 | Rockwell | Coal | Unknown | | 300° C. | 15 | minutes | 96% |
| 1983 | Rockwell | Biomass | 0.1 | gram | 175° C. | 15 | minutes | 82% |
| 1983 | Rockwell | Sewage | 0.15 | gram | 250° C. | 15 | minutes | 77% |

| | | | | | | | |
|---|---|---|---|---|---|---|---|
| 2001 | SRT | Methane | multi-gram | 200° C. | 0.1 | seconds | 100% |

In 1983 Rockwell International published an informative study on the bromination of coal (bituminous and lignite), biomass (Douglas fir, sugar cane, water hyacinth, and kelp), and milorganite (sewage sludge) in the presence of water. HBr yields at different temperatures and reaction times were determined. The HBr yield is the amount of HBr produced divided by the total amount of HBr that could be produced based on the amount of hydrogen in the sample (i.e., yield_{actual}/yield_{theoretical}). The carbonaceous material water and bromine were placed in a glass ampoule, sealed, and heated at predetermined temperatures and times, as indicated in Tables 2, 3 and 4. Small amounts of reactants were used in these experiments, on the order of 0.1 grams carbonaceous material, 1 gram water, and 1 gram bromine. After the reaction, the un-reacted bromine was boiled off and the HBr concentration was determined by titration with NaOH.

FIG. 1 illustrates a summary of prior art results from the Rockwell study for the bromination of coal, biomass, and milorganite. The numerical results are shown in Table 2 for the bromination of bituminous coal, Table 3 for the bromination of biomass and Table 4 for the bromination of milorganite.

TABLE 2
Bituminous Coal

| Temp | Time | Yield |
|---|---|---|
| Celsius | hr | % theory |
| 155 | 2 | 35 |
| 155 | 18 | 43 |
| 155 | 42 | 52 |
| 155 | 68 | 58 |
| 155 | 100 | 59 |
| 250 | 2 | 58 |
| 250 | 10 | 62 |
| 250 | 58 | 75 |
| 250 | 72 | 80 |
| 250 | 100 | 80 |
| 300 | 0.25 | 96 |
| 300 | 0.5 | 97 |
| 300 | 1 | 98 |
| 300 | 24 | 99 |
| 300 | 72 | 99.5 |

TABLE 3
Biomass

| Temp | Time | Yield |
|---|---|---|
| Celsius | hr | % theory |
| 150 | 0.25 | 68 |
| 175 | 0.25 | 82 |
| 250 | 0.5 | 94 |

TABLE 4
Milorganite

| Temp | Time | Yield |
|---|---|---|
| Celsius | hr | % theory |
| 150 | 0.25 | 49 |
| 175 | 0.25 | 58 |
| 200 | 0.25 | 70 |
| 225 | 0.25 | 73 |
| 250 | 0.25 | 77 |
| 250 | 0.5 | 78 |
| 300 | 2 | 83 |
| 300 | 16 | 86 |

The data suggests that bromine readily reacts with coal, biomass, and milorganite at elevated temperatures. It was found that many materials would form an initial amount of HBr very rapidly, but that higher temperatures were needed to get complete conversion of the hydrogen feedstock. This refractory fraction was resistant to bromination and required higher reaction temperatures. At 250° C. 80% of the coal reacted, while at 300° C. nearly all the coal was consumed. The Rockwell study suggested that there would be a higher temperature at which 100% of the biomass and milorganite would be converted. However, the researchers did not investigate this process beyond 250° C. and 300° C. respectively.

Some of the bromine used reacted with ash in the carbonaceous material to form soluble and insoluble bromide compounds. Bromine may be recovered from these compounds by reacting with 5% by weight sulfuric acid to form metal sulfates and additional HBr. The metals may then be recovered as hydroxides after neutralization with lime. These two steps reduce the amount of ‘lost’ bromine from 0.26%-0.63% to roughly 0.001% per bromination reaction. FIG. 2 shows the baseline design for such a system. Details of the baseline process are disclosed in Rockwell's U.S. Pat. No. 4,105,755, entitled “Hydrogen Production,” which is entirely incorporated by reference herein.

### Capture and Conversion of Regulated and Unregulated Pollutants

Coal-fired power plants (also “coal power plants” herein) are responsible for 67% of sulfur oxide (SOx), 22% of nitrogen oxide (NOx) and 41% of mercury (Hg) emissions in the U.S., according to Pollution on the Rise. Local Trends in Power-plant Pollution, Penn Environment Research and Policy Center, January 2005, which is entirely incorporated by reference herein. Hazardous Air Pollutants (HAP) are also emitted by coal power plants. The amount of SOx and NOx emitted from coal power plants, chemical operations and manufacturing facilities is limited by environmental air discharge permits issued by local, state, federal and/or regulatory agencies worldwide. The limits for these emissions are being reduced. The Clean Air Act's acid rain program imposes limits on SO₂ emissions, and the Clean Air Interstate Rules and Clean Air Mercury Rules (and any future legislation) can impose limits on NOx and Hg emissions, while imposing further limits on SO₂ emissions. Accordingly, a process to remove these chemicals efficiently and economically is needed.

The deleterious effects of these pollutants include the formation of ground level ozone and acid rain, which is an aqueous solution of sulfuric acid (H₂SO₄). Acid rain poses several problems, such as acidifying bodies of water and damaging forests. These emissions also contribute to respiratory problems, reduced atmospheric visibility, and the corrosion of materials.

### Sulfur Oxides: SOx

Coal used in coal-fired power plants contains a considerable amount of sulfur, which is oxidized to SOx (also referred to as ‘sulfur oxide’ which includes, e.g., SO₂ and SO₃) during combustion. Conventional methods for removing sulfur oxides include the use of wet alkaline scrubbers to convert SO₂ into SO₃, followed by absorbing the SO₃ into a water solution to form sulfuric acid, which is then reacted with an alkaline agent, such as lime or limestone, to form gypsum, (CaSO₄). This process, used in about 95% of the flue gas desulfurization (FGD) systems in the United States, requires a consumable reagent and produces a waste product that must be dried and disposed of in an environmentally-friendly fashion. While conventional scrubbers achieve removal efficiencies in excess of 90%, the quantity of SOx emitted is still considerable, necessitating a need for improvements in SOx removal techniques.

The European Research Centre developed and patented a process for controlling sulfur dioxide power-plant emissions through the following reaction (‘aq’ designates a 1 M (mole/liter) solution, and should not be taken as the exact condition used, but as an example condition):

SO₂(g)+Br₂(aq)+2H₂O(l)→H₂SO₄(aq)+2HBr(aq) (18)

ΔH°=−281kJ/mole ΔG°=−182kJ/mole (19)

U.S. Pat. No. 4,668,490, which is entirely incorporated by reference herein, teaches a method of reacting SO₂ with bromine per reaction (18) above to form sulfuric acid (H₂SO₄) and hydrobromic acid (HBr); the regeneration of bromine and production of hydrogen from the latters electrolysis; and a method for concentrating the sulfuric acid to a saleable product. U.S. Pat. No. 5,674,464, which is entirely incorporated by reference herein, teaches a method of regenerating bromine catalytically from the reaction of hydrogen bromide with oxygen over a catalyst.

### Nitrogen Oxides: NOx

The NOx in waste gas streams is typically composed of NO, NO₂, N₂O₃, N₂O₄ and N₂O₅ and may include N₂O, HNO₂ and HNO₃. Most of these can be easily removed through conventional alkaline wet scrubbers with the exception of NO. To remove NO it must be oxidized to NO₂ prior to removal by conventional scrubbing.

The typical method of removing NO is by Selective Catalytic Reduction (SCR) or Selective Noncatalytic Reduction (SNCR). The former uses a catalyst, such as vanadium pentoxide, to oxidize NO to NO₂, while the latter does not use a catalyst. In both case ammonia (NH₃) is added to the flue gas to react with the NOx (e.g., NO, NO₂) species. SCR and SNCR reactions include the following:

3NO₂(g)+4NH₃g)→7/2N₂(g)+6H₂O(g) ΔH°=−1367kJ/mol (20)

3NO(g)+2NH₃(g)→5/2N₂(g)+3H₂O(g) ΔH°=−904kJ/mol (21)

NO(g)+½O₂(g)→NO₂(g) ΔH°=−57kJ/mol (22)

U.S. Pat. No. 5,328,673, which is entirely incorporated by reference herein, teaches using an aqueous solution of hydrochloric acid to oxidize NOx and SOx pollutants. The pollutants are converted to acids and then neutralized prior to disposal. The process consumes its reagent and does not produce any saleable products. U.S. Pat. No. 4,619,608, which is entirely incorporated herein by reference, teaches using chlorine to oxidize NOx, SOx and H₂S pollutants to facilitate the removal of their oxidized forms through water absorption.

### Mercury

The Clean Air Act has set a pollution threshold for Mercury emissions, which is regulated by the United States Environmental Protection Agency (EPA). Coal-fired power plants account for a significant fraction of total mercury emissions. This emitted mercury is found in a variety of forms, including elemental mercury and oxidized mercury compounds. Highly soluble mercury compounds may be removed in a wet scrubber; however insoluble mercury compounds, such as elemental mercury, are difficult to remove via conventional removal methods. Therefore, it is desirable to oxidize the elemental mercury to a form that may be more readily captured.

U.S. Pat. No. 5,900,042 (“'042 patent”), which is entirely incorporated by reference herein, teaches reacting elemental mercury with aqueous solutions of chlorine, bromine, iodine and hydrochloric acid. The '042 patent teaches the oxidation of mercury and its subsequent absorption by water in the presence of NOx and/or SOx.

### Other Hazardous Air Pollutant

The Clean Air Act designates numerous substances as Hazardous Air Pollutants (HAPs). These pollutants can lead to health issues. The standard method for their removal is to capture using, e.g., electrostatic precipitators and bag filters as used for particulate matter removal. However, these methods can be costly. There is a need for new technologies capable of capturing these pollutants.

### Particulate Matter

Particulate matter (PM) includes small particles of carbon, silca, alumina and other species created or formed in the combustion of coal. PM is formed from the melting of coal constituents in a coal-fired boiler and their condensation in the flue gas stream into very fine particles that are small enough to behave as gases. Much PM is removed as fly-ash using existing removal technologies, such as filter bag houses and electrostatic precipitators, but significant quantities are still released to the environment. Particulate matter is responsible for respiratory illness. Regulations currently limit the emission of particulate matter into the environment.

### Capture and Conversion of Regulated and Unregulated Pollutants: Hydrogen Sulfide

H₂S is an odorous and corrosive (environmental) pollutant with toxicity worse than hydrogen cyanide (HCN). It is commonly found in natural gas, and is made at oil refineries and waste treatment facilities. In 1996 more than 5 million tons of H₂S waste was generated through hydro-desulphurization to remove sulfur compounds from crude oil, according to T-Raissi, A. Technoeconomic Analysis of Area II Hydrogen Production—Part 1, in Proceedings of the 2001 DOE Hydrogen Program Review, DE-FC36-00GO10603, 2001.

H₂S deactivates industrial catalysts, is corrosive to metal piping and damages gas engines, and therefore must be eliminated from many industrial processes, or removed from biogas before it is used or sold. Presently H₂S is removed by chemical absorption with an iron oxide sponge or an amine solution. The resulting H₂S laden product is then heated to high temperatures to release the H₂S under controlled conditions for processing in sulfur producing plants that use the modified-Claus process (see below). A third of the sulfide gas stream is oxidized by air or oxygen to form sulfur dioxide. This stream is mixed with the remaining two-thirds of the sulfide stream over a catalyst to produce sulfur via the Claus reaction:

2H₂S(g)+SO₂(g)→3S(s)+2H₂O(g) ΔH°=−145kJ/mole ΔG°=−90kJ/mol (23)

Sulfur is not very valuable and is typically burned to produce more useful sulfuric acid. Moreover, modified-Claus plants are expensive to operate and typically treat only 98% of the sulfide gases, requiring a tail gas unit to remove the remaining sulfide gases. The above-mentioned processes are not particularly attractive when considering the capital cost, energy consumption, plant footprint requirements, and manpower, operating and maintenance costs.

Other methods for removing hydrogen sulfide include absorption on activated carbon and scrubbing processes using a caustic soda solution. These methods are expensive and can produce considerable waste water, requiring further treatment and disposal.

Hydrogen Production from HBr

Once an aqueous HBr solution, preferably an azeotrope or more concentrated solution, is produced, it may be electrolyzed using commercially available electrolysis cells to produce hydrogen and bromine. Such cells are extensively used by the chlor-alkali industry. The regenerated bromine may be used for continuing the bromination processes described herein. Compared to the theoretical energy for the electrolysis of water at +287kJ/mol H₂ (eq 11), actual HBr electrolysis requires less energy as shown:

Electrolysis: 2HBr(aq,azeotrope)→H₂(g)+Br₂(aq) ΔH°=+217kJ/mol H₂ (24)

Referring to equations 12-17, which show the bromination of cellulose and carbon, it is evident the energy required to produce hydrogen can be significantly reduced if a carbon feedstock is utilized.

Overall: C₆H₁₀O₅(s)+7H₂O(l)→12H₂(g)+6CO₂(g) ΔH°=+50kJ/mol H₂ (25)

Overall: C₆H₁₀O₅(s)+7H₂O(g)→12H₂(g)+6CO₂(g) ΔH°=+24kJ/mol H₂ (26)

Overall: C(s)+2H₂O(l)→2H₂(g)+CO₂(g) ΔH°=+89kJ/mol H₂ (27)

Overall: C(s)+2H₂O(g)→2H₂(g)+CO₂(g) ΔH°=+45kJ/mol H₂ (28)

The HBr produced may be in different forms. The reaction thermodynamics are shown for alternative initial HBr and final product states, ‘aq’ designates a 1 M (mole/liter) solution.

Electrolysis: 2HBr(aq)→H₂(g)+Br₂(l) ΔH°=+243kJ/mol H₂ (29)

Electrolysis: 2HBr(aq)→H₂(g)+Br₂(aq) ΔH°=+240kJ/mol H₂ (30)

A second option for splitting HBr involves gas-phase electrolysis. HBr boils at −66.8° C., but is very soluble in water. It forms an azeotrope with water at a concentration of about 47.5%, the boiling point of which is about 126° C. Present proton exchange membrane (PEM) cells can operate at temperatures up to 200° C., making gas-phase electrolysis an option for reducing the energy required to split HBr by 50%. The reaction thermodynamics are described in the equations below for gas (g), liquid (l) or aqueous (aq, 1 M) phase products:

Electrolysis: 2HBr(g)→H₂(g)+Br₂(g) ΔH=+104kJ/mol H₂ (31)

Electrolysis: 2HBr(g)→H₂(g)+Br₂(l) ΔH=+73kJ/mol H₂ (32)

Electrolysis: 2HBr(g)→H₂(g)+Br₂(aq) ΔH=+70kJ/mol H₂ (33)

A third option for splitting HBr involves reaction with a copper packed bed (hereinafter “bed”), a silver bed, or a bed comprising another metal. In this process, bromine reacts with the metal, releasing hydrogen, which is typically captured. Upon the completion of the reaction, the bed is heated to thermally dissociate the bromine from the metal for further bromination. The thermodynamics of such reactions are shown in the equations below for copper and silver beds:

Copper bed: HBr(g)+Cu(s)→CuBr(s)+½H₂(g) ΔH=−68kJ/mol H₂ (34)

CuBr(s)→Cu(s)+½Br₂(g) ΔH=+120kJ/mol H₂ (35)

Silver bed: HBr(g)+Ag(s)→AgBr(s)+½H₂(g) ΔH=−64kJ/mol H₂ (36)

AgBr(s)=Ag(s)→½Br₂(g) ΔH=+116kJ/mol H₂ (37)

The hydrogen produced from hydrogen bromide may be reacted with oxygen in air to release more energy than needed to create the hydrogen:

H₂(g)+½O₂(g)→H₂O(g) ΔH=−242kJ/mol H₂ (38)

H₂(g)+½O₂(g)→H₂O(l) ΔH=−286kJ/mol H₂ (39)

Energy Storage with Reversible Fuel Cells

Hydrogen bromide proton exchange membrane electrolyzers have been produced, which can operate as fuel cells to produce electricity through the reaction of hydrogen with bromine, oxygen or another oxidizer. Cells utilizing hydrogen and chlorine were the first fuel cells operated due to greatly augmented reaction rates when compared to hydrogen and oxygen. The ability to use a reversible fuel cell with hydrogen and bromine allows the electrolyzer to regenerate bromine from hydrogen bromide, which can be operated as a fuel cell to generate electricity from the reaction of hydrogen with an oxidizer. This is important when the time value of electricity is considered which favors electrical consumption during off-peak night periods, and electricity generation during on-peak daytime periods. U.S. Pat. No. 5,219,671, which is entirely incorporated herein by reference, discloses the use of reversible hydrogen-halogen fuel cells for energy storage.

The reaction between hydrogen and a halogen is known to be very efficient, allowing hydrogen and the halogen to be reacted to produce a hydrogen halide and electricity, and then decomposed with electricity to regenerate hydrogen and halogen with close to theoretical energy. Round trip electric-to-electric efficiencies of 80% have been demonstrated at high current densities exceeding 3 kA/m².

### Synthesizing Methanol, Ethanol and Other Liquid Fuels

Due to the difficulty in transporting and storing gaseous hydrogen, and the absence of infrastructure and significant demand for hydrogen as a vehicle-fuel, hydrogen is reacted with co-produced carbon dioxide to produce methanol. This methanol may then be hydrated in the presence of sulfuric acid to produce ethanol, which may be burned in existing flex-fuel vehicles or blended with regular gasoline for existing gasoline-fuelled vehicles. The reactions for these steps are exothermic and are shown in the equations below:

Methanol Synthesis: CO₂(g)+3H₂(g)→CH₃OH(g)+H₂O(g) ΔH=−38kJ/mole (40)

Ethanol Synthesis: 2CH₃OH(l)→CH₃CH₂OH(l)+H₂O(l) ΔH=−86kJ/mole (41)

Six moles of hydrogen are required for each mole of ethanol produced. All of the steps proposed are exothermic, with the exception of dissociating hydrogen from HBr. Table 5 (below) shows the chemicals required and made from one pound of carbonaceous starting species.

TABLE 5

| Reacting | Cost | Water | HBr | CO₂ | H₂ | Methanol | Ethanol |
|---|---|---|---|---|---|---|---|
| Species | ($/ton) | (lbs) | (lbs) | (lbs) | (lbs) | (lbs) | (lbs) |
| Biomass | 20-50 | 0.778 | 12.0 | 1.63 | 0.148 | 0.790 | 0.568 |
| Coal | 10-40 | 2.503 | 26.5 | 2.34 | 0.327 | 1.746 | 1.255 |
| Carbon | Ex | 3 | 27.0 | 3.67 | 0.333 | 1.778 | 1.278 |

1lb Cellulose+0.778lbs H₂O→0.148lbs H₂+1.63lbs CO₂ (42)

or→0.790lbs Methanol+0.543lbs CO₂+0.444lb H₂O (43)

or→0.568lbs Ethanol+0.543lbs CO₂+0.667lb H₂O (44)

1lb Coal+2.50lbs H₂O→0.327lbs H₂+3.117lbs CO₂ (45)

or→1.746lbs Methanol+0.72lbs CO₂+1.041lb H₂O (46)

or→1.255lbs Ethanol+0.72lbs CO₂+1.532lb H₂O (47)

1lb C+3.00lbs H₂O→0.333lbs H₂+3.667lbs CO₂ (48)

or→1.78lbs Methanol+1.22lbs CO₂+1.00lb (49)

or→1.28lbs Ethanol+1.22lbs CO₂+1.50lb H₂O (50)

Tables 6 and 7 detail the mass balances of the reactions discussed herein. Table 6 shows the amount of hydrogen, methanol, and ethanol that can be made from each pound of reacting species (“species”) and the pounds of reacting species required to make a gallon of methanol and ethanol.

TABLE 6

| | lb H₂ per | lb methanol per | lb ethanol per | lb species per | lb species per |
|---|---|---|---|---|---|
| Reacting Species | lb species | lb species | lb species | gallon methanol | gallon ethanol |
| Cellulose (C₆H₁₀O₅) | 0.148 | 0.790 | 0.568 | 8.394 | 11.571 |
| Coal (C₁₃₅H₉₆O₉NS) | 0.327 | 1.746 | 1.255 | 3.798 | 5.236 |
| Carbon (C) | 0.333 | 1.778 | 1.278 | 3.731 | 5.143 |

Table 7 shows the amount of carbon dioxide emitted per pound of hydrogen, methanol, and ethanol, the fraction of hydrogen that comes from the water co-reactant, and the percentage of carbon dioxide reused from the bromination step to make methanol and ethanol.

TABLE 7

| | lb CO₂ per | lb CO₂ per | lb CO₂ per | lb CO₂ per | % H₂ from | % CO₂ |
|---|---|---|---|---|---|---|
| Reacting Species | lb H₂ | lb methanol | lb ethanol | gallon ethanol | water | reused |
| Cellulose (C₆H₁₀O₅) | 11 | 0.688 | 0.957 | 6.286 | 58% | 67% |
| Coal (C₁₃₅H₉₆O₉NS) | 9.5192 | 0.410 | 0.570 | 3.747 | 85% | 77% |
| Carbon (C) | 11 | 0.688 | 0.957 | 6.286 | 100% | 67% |

Table 8 shows the amount of water required and carbon dioxide produced in the first bromination reaction, and the amount of carbon dioxide not used and water produced in the methanol/ethanol synthesis reactions. All production numbers are indicated per pound of reacting species.

TABLE 8

| | lb H₂O per | lb CO₂ per | lb CO₂ not | lb H₂O per | lb H₂O per |
|---|---|---|---|---|---|
| Reacting Species | lb species | lb species | used per lb | lb species (meth) | lb species (eth) |
| Cellulose (C₆H₁₀O₅) | 0.778 | 1.630 | 0.543 | 0.444 | 0.667 |
| Coal (C₁₃₅H₉₆O₉NS) | 2.503 | 3.116 | 0.716 | 1.041 | 1.532 |
| Carbon (C) | 3.000 | 3.667 | 1.222 | 1.000 | 1.500 |

Accordingly, there is a need in the art for efficient energy production processes as well as chemical processes that can utilize biomass, methane, sewage, nitrogen, sulfur and phosphorus pollutants, as well as other waste material, to generate energy, while reducing the energy needed to make useable fuels, such as, e.g., hydrogen (H₂), methanol (CH₃OH), ethanol (C₂H₅OH), other alcohols, hydrocarbons (including high molecular weight hydrocarbons and aromatic compounds), aldehydes, ketones, ammonia (NH₃) and urea. Additionally, there is a need for processes to capture and treat pollutants, such as, e.g., mercury, lead and other metals, and nitrogen oxide (NOₓ) and sulfur-containing species (e.g., elemental sulfur, SO₂, H₂SO₄).

### SUMMARY OF THE INVENTION

The invention provides systems, apparatuses, devices and methods for reacting a halogen-containing chemical with a reactant to produce energy. Such systems may include one or more reaction modules (also “reactors” herein) configured for reacting a carbon-containing, a sulfur-containing, and/or nitrogen-containing chemical with a first halogen-containing chemical to produce a second halogen-containing chemical, which can be dissociated to produce the first halogen-containing chemical. In some embodiments, the second halogen-containing chemical can be dissociated in an electrolyzer, such as an electrolyzer as part of a reversible fuel cell.

An aspect of the invention provides methods for generating energy and/or fuel from the halogenation of a carbon-containing material. In an embodiment of the invention, a method comprises supplying the carbon-containing material and a first halogen-containing chemical to a reactor. The carbon-containing material and the halogen-containing chemical are reacted in the reactor to form a second halogen-containing chemical and carbon dioxide. The second halogen-containing chemical is dissociated (e.g., electrolyzed) to form the first halogen-containing chemical and hydrogen gas (H₂). In an embodiment of the invention, the second halogen-containing chemical is dissociated into the first halogen-containing chemical and H₂ in the reactor. In such a case, the reactor may be configured for halogenation and electrolysis. In another embodiment of the invention, the first halogen-containing chemical is Br₂ and the second halogen-containing chemical is HBr. In another embodiment of the invention, any carbon dioxide formed during reaction is directed to a prime mover (e.g., turbine) to generate electricity. In yet another embodiment of the invention, a sulfur-containing chemical is supplied to the reactor. In an embodiment of the invention, the sulfur-containing chemical can include one or more of H₂S, elemental sulfur, SO₂, SO₃ and sulfuric acid. The sulfur-containing chemical can react with the first halogen-containing chemical to yield the second halogen-containing chemical.

Another embodiment of the invention provides a method for brominating a carbon-containing material. The method comprises supplying a carbon-containing material, Br₂ and H₂O to a reaction module; reacting the carbon-containing material, Br₂ and H₂O in the reaction module (or reactor) to form HBr and CO₂; and dissociating (e.g., electrolyzing) HBr into H₂ and Br₂. In an embodiment of the invention, the carbon-containing chemical, Br₂ and H₂O are reacted at a temperature between about 1° C. and about 500° C., or between about 100° C. and about 400° C., or between about 200° C. and about 350° C. In another embodiment of the invention, the carbon-containing chemical, Br₂ and H₂O are reacted at a pressure between about 1 atm and about 500 atm, or between about 15 atm and about 400 atm, or between about 150 atm and 300 atm, or between about 1 atm and 15 atm. Yet another embodiment of the invention provides a method for cleaning a contaminated gas stream. The method comprises providing a contaminant in a reactor; providing a first halogen-containing chemical in the reactor; reacting the contaminant with the first halogen-containing chemical to form a second halogen-containing chemical; and dissociating the second halogen-containing chemical to form the first halogen-containing chemical and hydrogen (H₂). In an embodiment of the invention, the second halogen-containing chemical is dissociated in the reactor. In another embodiment of the invention, the first halogen-containing chemical is selected from F₂, Cl₂, Br₂ and I₂ gases. In yet another embodiment of the invention, the second halogen-containing chemical is selected from HF, HCl, HBr and HI. In still another embodiment of the invention, the contaminant includes one or more of a carbon-containing chemical, elemental sulfur, H₂S, SO₂, SO₃, NO, NO₂, N₂O and ash.

Another aspect of the invention provides reactors, such as halogenation reactors, reversible fuel cells, fuel cells and combined (or dual) halogenation and electrolysis reactors. In an embodiment of the invention, a halogenation reactor comprises a first module configured for reacting a carbon-containing material and a first halogen-containing chemical to form a second halogen-containing chemical. The halogenation reactor further comprises a second module configured for dissociating the second halogen-containing chemical into the first halogen-containing chemical and hydrogen gas (H₂). In an embodiment of the invention, the halogenation reactor can be a fuel cell. In another embodiment of the invention, the halogenation reactor can be a reversible fuel cell. In yet another embodiment of the invention, the halogenation reactor further comprises a proton exchange membrane for separating protons from ionic fragments of the second halogen-containing chemical. In still another embodiment of the invention, the first module and the second module can be the same module. In such a case, reaction between the carbon-containing material and the first halogen-containing chemical, and dissociation of the second halogen-containing chemical can take place in the same reactor or reaction vessel. In still another embodiment of the invention, the second module is configured for reacting H₂(g) with O₂(g) to form water. In still another embodiment of the invention, the second module is configured for reacting H₂(g) with the first halogen-containing chemical to form the second halogen-containing chemical.

Another embodiment of the invention provides an energy production system, comprising a reversible fuel cell configured for reacting a carbon-containing material and a first halogen-containing chemical to form a second halogen-containing chemical and carbon dioxide. The reversible fuel cell is further configured for dissociating the first halogen-containing chemical into the second halogen-containing chemical and hydrogen gas (H₂). The system further comprises a primer mover for generating energy from one or both of H₂(g) and CO₂(g).

In preferable embodiments of the invention, processes and systems of components provide chemicals and energy from waste or non-waste feedstock. Different implementations of the processes of preferable embodiments of the invention are capable of reacting a variety of carbon, nitrogen, sulfur and phosphorus-containing chemicals or materials to produce electricity and a range of chemicals, including hydrogen, water, carbon dioxide, ammonia, methanol, ethanol, sulfuric acid, nitric acid, phosphoric acid and halogen-containing acids (e.g., HBr, HCl, HI, HF), as well as ammonium and metal sulfates, nitrates and phosphates. Reactants (also “feedstock compounds” herein) of particular interest include, without limitation, carbon, cellulose, biomass, coal, petroleum coke, carbon monoxide, carbon dioxide, nitrogen oxide, nitrogen dioxide, nitrates, sulfur, sulfur dioxide, sulfur trioxide, hydrogen sulfide, sulfates, phosphorus and nitrogen compounds, as well as biowaste, such as sewage, manure and crop residues. Feedstock (or waste) streams can contain one or more metals, biological and chemical contaminants, including mercury, arsenic, lead, cadmium, tellurium, cadmium tellurium, hormones, pharmaceuticals, pesticides, herbicides, and other organic and inorganic contaminants, some of which may be classified as hazardous air pollutants. Methods and processes of preferable embodiments of the invention can capture, react with, and/or break down these contaminates to provide an environmentally friendly ash having, e.g., inert and/or un-reacted compounds, that may be recycled or disposed.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments of the invention. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments of the invention.

FIG. 1 is a plot of the bromination of coal, biomass, and milorganite.

FIG. 2 shows a prior art system for the bromination of coal, biomass, and milorganite.

FIG. 3 is a plot of bromination reactor temperature versus HBr concentration for burning biomass with bromine.

FIG. 4 is a plot of electrolysis voltage versus temperature for a 47.5% by weight HBr azeotrope in water.

FIG. 5 is a plot of energy versus pressure for the compression of hydrogen (H₂(g)).

FIG. 6 illustrates the power produced from expanding CO₂ to 150 psi from a given reactor pressure and temperature.

FIGS. 7A-B illustrate system for halogenating reactants.

FIG. 8 illustrates the wall of a reactor.

FIG. 9 illustrates a system to produce hydrogen in which the reactor and electrolyzer are provided in the same unit.

FIG. 10 illustrates a system comprising a reactor and electrolyzer in addition to a reversible fuel cell.

FIG. 11 illustrates the operation of a reversible fuel cell.

FIG. 12 illustrates how the same cell membrane electrode assemblies may be arranged and operated to generate products or electricity.

FIGS. 13A-B illustrate how the reversible fuel cell may be configured to both electrolyze a halogen-containing chemical (HBr as illustrated) halide and react hydrogen with an oxidizer (Br₂ and/or O₂, as illustrated) simultaneously (or at a later time) to produce power required for the electrolysis of a halogen-containing chemical.

FIG. 14 illustrates another method of arranging the cells to allow the production of energy from system products, in accordance with an embodiment.

FIGS. 15A-C illustrate how a system may be operated to make net hydrogen and provide energy while continuously making a halogen-containing chemical from the halogenation of input matter (feedstock).

FIG. 16 illustrates how smaller spray drop sizes can capture more particulate matter than larger drop sizes for a constant flow.

FIG. 17 illustrates an emission control system.

FIG. 18 illustrates an emission control facility.

FIG. 19 illustrates the combination of a pre-concentrator, reactor and final scrubber in a single unit (or tower).

FIG. 20 illustrates how a condenser-demister configured to capture a halogen-containing chemical through a series of sequential washing and contact stages.

FIG. 21 illustrates a flowchart of a method to halogenate one or more reactants.

FIG. 22 illustrates a flowchart of a method to brominate reactants and utilize high pressure gas to operate a prime mover.

FIG. 23 illustrates a flowchart of a method to brominate reactants.

FIG. 24 illustrates a flowchart of a method to brominate reactants and utilize high-pressure gas to operate a prime mover.

FIG. 25 illustrates a flowchart of a method to brominate reactants and recover a portion of a bromine compound for optional reuse in a bromination reaction chamber module.

FIG. 26 illustrates a flowchart of a method to brominate reactants and utilize high-pressure gas to operate a prime mover.

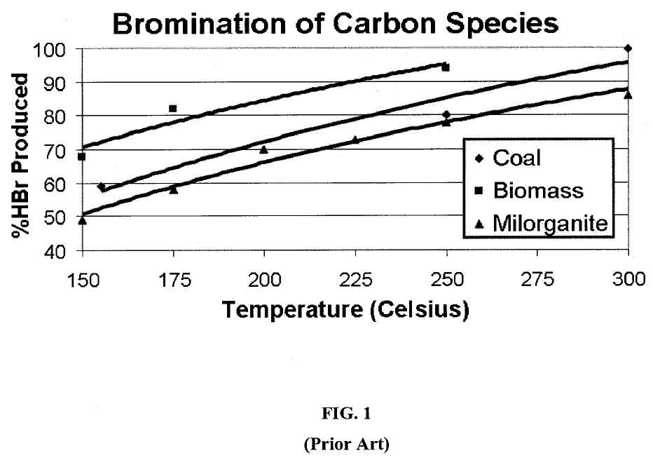

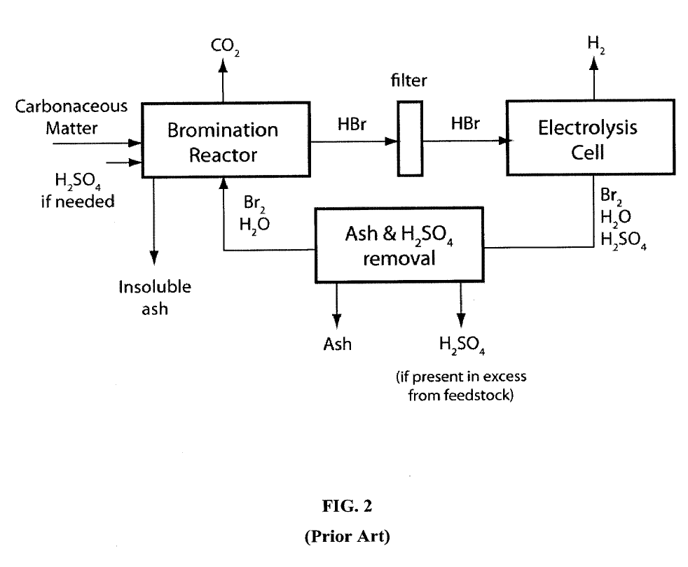

### DETAILED DESCRIPTION OF THE INVENTION

While various embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

Methods, processes, devices, structures, apparatuses and systems of aspects and embodiments of the invention can overcome various problems and limitations associated with prior art systems and methods. In some embodiments of the invention, methods and apparatuses for the treatment of waste material to produce useful products are provided. In other embodiments, methods and apparatuses for the treatment of waste material and the creation of high-pressure gas to operate a prime mover (e.g., turbine, motor, turbine and generator combination, compressor) are provided. In still other embodiments, methods and apparatuses for integrating the ability to store energy and providing peaking power are provided. It will be appreciated that several types of modules can be utilized to process various reactants and products.

In embodiments of the invention, the bromination of carbon-containing material, such as, e.g., carbonaceous material or biomass, provides for meeting domestic energy requirements, thus reducing the need for oil and natural gas, and reducing pollution. The basic methods and processes of preferable embodiments of the invention have several advantages over prior art methods and processes, which include, without limitation:
1. The theoretical energy efficiency of the process for producing hydrogen is 67% when electricity is produced at 40% efficiency. The efficiency is greater than that for electricity production because the energy contained in the biomass feedstock is considered free and not accounted in the fossil energy in vs. hydrogen energy out balance.
2. Under conditions in which only 90% of carbon-containing material (e.g., biomass) is brominated, an electrolysis cell (also “electrolyzer” herein) operates at about 90% cell efficiency, and the resulting HBr is approximately a 60% by weight solution at 150° C. Hydrogen is produced at about 49% energy efficiency.
3. Conventional methods for producing hydrogen (steam reforming and partial oxidation) require limited and expensive fossil fuel, in addition to imparting significant damage to the environment. The electrical energy required for electrolyzing HBr can come from hydroelectric, wind, solar, nuclear, or coal-fired power plants, allowing the full utilization of these facilities during off-peak times, while enabling the process to occur in an environmentally-friendly fashion.
4. Brominating and electrolyzing at high pressures increases the rates of reaction, while allowing hydrogen to be generated at high pressure (2,000 psi), thereby reducing or eliminating the need for further hydrogen compression.
5. Brominating and electrolyzing at high temperatures accelerates the reactions, while allowing high temperature HBr electrolysis with significantly reduced electrical energy requirements (a 40% reduction in electrical energy required at 200° C. compared to 50° C. for 47.5% aqueous azeotrope).
6. The bromination process acts as a gas generator by producing high temperature and high pressure carbon dioxide along with other gases, such as steam and nitrogen, which may be expanded through a primer mover, such as a turbine, to produce power.
7. The bromination process is highly exothermic, providing the opportunity to generate steam or another working fluid for use in thermal electric generating cycles, such as, e.g., rankine electricity generating cycles.
8. The process provides an attractive means of utilizing energy contained in biomass with higher throughput and lower costs than prior art methods.
9. The process can use any carbon-containing material, including any carbon-containing material in waste streams (e.g., sewage).

In embodiments of the invention, providing a first halogen-containing chemical, a carbon-containing chemical and water to a reactor (e.g., halogenation reactor and electrolyzer combined in a single reactor) can yield CO₂ and a second halogen-containing chemical. CO₂ can be directed through a prime mover (e.g., turbine) to generate energy or used in liquid fuel synthesis. The second halogen-containing chemical can be decomposed into hydrogen and the first halogen-containing chemical, which can be recycled into the reactor.

In other embodiments of the invention, providing a first sulfur-containing chemical (e.g., elemental sulfur, SO₂) and a first halogen-containing chemical (e.g., Br₂) to a reactor can yield a second halogen-containing chemical (HBr) and a second sulfur-containing chemical (e.g., elemental sulfur, H₂SO₄). By providing the sulfur-containing chemical at high pressure to a pressurized reactor, the size of the equipment can be reduced, leading to savings in equipment and process costs.

Various processes of embodiments of the invention separate bromine (Br₂) and HBr. Liquid bromine with the highest density can be concentrated at the bottom of a pressurized column or reactor, followed by a bromine-HBr aqueous solution at the top. Sulfur-containing gases are soluble and react exothermically with the elemental bromine liquid at the bottom and with the bromine-water solution forming HBr, sulfur and/or sulfuric acid. The process produces considerable thermal energy in the production of the by-products and the enthalpy of dissolution of HBr. In an embodiment of the invention, a pressurized carbon-containing gas (e.g., methane) is insoluble in the liquid column and its bubbling passage up through the column “carries” the sulfur-containing byproduct and aqueous HBr up to the top of the column via the turbulence of an insoluble gas rising and expanding in a liquid column. A glass frit or other porous device separating the pressurized gasses at the bottom from the pressurized liquid produces a very small bubble stream which allows for more intimate mixing and increased reaction rates.

In an embodiment of the invention, heat from the reactions can be removed with a spiral heat exchanger centrally located within a reactor or reaction column, which also aids in generating turbulence with the insoluble carbon-containing carrier gas. The heat is used to concentrate a portion of the dilute aqueous HBr solution which has been removed from the column for electrolysis into hydrogen and bromine, with the bromine-water solution re-introduced low into the pressurized column. In another embodiment of the invention, process heat is used to produce gaseous HBr for gas-phase electrolysis.

In an embodiment of the invention, to facilitate electrolysis of a halogen-containing chemical, acentral spiral heat exchanger can be used as the anode and the wall of column as the cathode, with solid particulates suspended in the electrolyte behaving as a “slurry” electrode. See U.S. Pat. No. 4,239,607, which is entirely incorporated herein by reference.

Reaction columns (or reactors, reaction vessels) and heat-exchangers can be formed of Hexyloy® SG silicon carbide, an electrically conductive analog of sintered silicon carbide. Alternatively, reactors can be coated with an electrically conductive glass material containing oxides of titanium (i.e., TiOx). See U.S. Pat. No. 2,933,458, which is entirely incorporated herein by reference.

In an embodiment of the invention, a carbon-containing material, a sulfur-containing chemical and a first halogen-containing chemical are provided in the same reactor. This enables simultaneous bromination and ash-treatment, thereby ensuring that all or essentially all of the first halogen-containing chemical (e.g., Br₂) is converted to a second halogen-containing chemical (e.g., HBr). In a preferable embodiment of the invention, slurry electrodes in an agitated single reactor (or electrolyzer) tank configuration can be used.

In another embodiment of the invention, a first halogen-containing chemical can be photolyzed to a second halogen-containing chemical to get higher yields at lower temperatures and pressures. In such a case, concentrated solar or laser energy can be provided using a quartz port in a reactor to photolyze the first halogen-containing chemical (e.g., HBr) to the second halogen-containing chemical (e.g., Br₂). In an embodiment, the electrolyte can be seeded with one or more Group VIII transitional metals. See U.S. Pat. No. 5,219,671, which is entirely incorporated herein by reference.

### DEFINITIONS

“Halogen-containing species” (also “halogen-containing compound”, “halogen-containing chemical” and “halogen-containing material” herein) refers to any chemical species comprising one or more halogen atoms (e.g., F, Cl, Br, I). A halogen-containing species may be a chemical species selected from bromine (Br₂), fluorine (F₂), chlorine (Cl₂), iodine (I₂), hydrogen flouride (HF), hydrogen chloride (HCl) and hydrogen iodide (HI). In some embodiments, a halogen-containing chemical may be a halogen-containing acid, such as, e.g., HF, HCl, HBr or HI. A halogen-containing compound can exist in any state, such as gaseous and/or liquid (or aqueous) states. While various embodiments of the invention make use of bromine (Br₂) and hydrobromic acid (HBr), it will be appreciated that other halogen-containing compounds, such as, e.g., Cl₂ and HCl or I₂ and HI, may be used in place of Br₂ and HBr.

“Sulfur-containing species” (also “sulfur-containing chemical” and “sulfur-containing material” herein) refers to any chemical species comprising one or more sulfur atoms. A sulfur-containing species may be a chemical species (or a chemical compound) selected from elemental sulfur (S), H₂S, HDS, D₂S, sulfur oxide (SOx, such as, e.g., SO, SO₂, SO₃), sulfurous acid (H₂SO₃) and sulfuric acid (H₂SO₄). A sulfur-containing species can exist in any form, such as solid, liquid, or gaseous (vapor) form. The skilled artisan will understand that various sulfur-containing species can exist in aqueous form. For example, sulfuric acid can exist in aqueous form.

“Carbon-containing species” (also “carbon species”, “carbon-containing chemical,” “carbon-containing matter” and “carbon-containing material” herein) refers to any chemical species comprising one or more carbon atoms. In embodiments of the invention, a carbon-containing species can be selected from a carbon-rich (carbonaceous) compound, coal, biomass, sewage, lignite, cellulose, animal manure, municipal solid waste, pulp, paper products, food waste, milorganite, alkanes (e.g., CH₄), alkenes (e.g., C₂H₄), alkynes (e.g., C₂H₂), aromatics (e.g., C₆H₆), alcohols (e.g., CH₃OH, CH₃CH₂OH), aldehydes and ketones. In some embodiments of the invention, biomass may be a carbon-containing species. A carbon-containing species can react to form other carbon-containing species.

“Nitrogen-containing species” (also “nitrogen-containing chemical” and “nitrogen-containing material” herein) refers to any species comprising one or more nitrogen atoms. A nitrogen-containing species may be N₂ or NOx (e.g., NO, NO₂, N₂O₃, N₂O₄, N₂O₅, N₂O, HNO₂ and HNO₃). A nitrogen-containing species can react to form other nitrogen-containing species.

“Phosphorous-containing species” (also “phosphorous-containing chemical” or “phosphorous-containing material” herein) refers to any species comprising one or more phosphorous atoms. A phosphorous-containing species can be phosphoric acid, or a compound comprising phosphate or organophosphorus. A phosphorous-containing species can react to form other phosphorous-containing species.

Processes of embodiments of the invention can yield various sulfur-containing species as products (or by-products). In some embodiments, sulfuric acid (H₂SO₄) is a product. In some applications, sulfuric acid may need to be added to the reactants. This can be achieved by adding a sulfur-containing species (e.g., S, SO₂) to a reactor. In other embodiments, elemental sulfur is a product. In still other embodiments, a sulfur oxide (SOₓ) is a product.

It will be appreciated that nitrogen-containing species, phosphorous-containing species, carbon-containing species, sulfur-containing species and halogen-containing species are not mutually exclusive. That is, a carbon-containing species can include one or more sulfur atoms.

In various embodiments, during reaction hydrogen halide, such as, e.g., hydrogen bromide (HBr) or hydrogen chloride (HCl), can be formed. Metal bromides can result from reaction with non-nitrogen, sulfur, carbon and phosphorus compounds.

Hydrogen Production from Carbon-Containing Waste

In an aspect of the invention, performing a bromination reaction at higher temperature can accelerate the burning (or combustion) of carbon-containing material with bromine. This enhances the generation of steam and other gases, increases the final HBr concentration, and decreases the energy required to produce hydrogen and regenerate bromine.

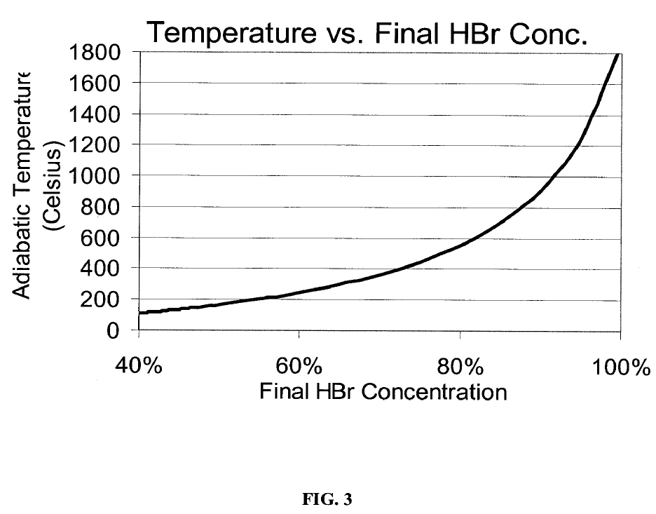

FIG. 3 is a plot showing bromination reactor temperature for burning cellulose with bromine, in accordance with an embodiment of the invention. This result assumes an initial temperature of about 27° C., an initial mixture of about 20% HBr solution with stoichiometric amounts of cellulose and bromine for reaction in the amount water required to produce the final HBr concentration.

In an embodiment of the invention, a carbon-containing chemical (e.g., cellulose), Br₂ and H₂O can be reacted at a temperature between about 1° C. and about 500° C., or between about 100° C. and about 400° C., or between about 200° C. and about 350° C. The carbon-containing chemical, Br₂ and H₂O can be reacted at a pressure between about 1 atm and about 500 atm, or between about 15 atm and about 400 atm, or between about 150 atm and 300 atm, or between about 1 atm and 15 atm.

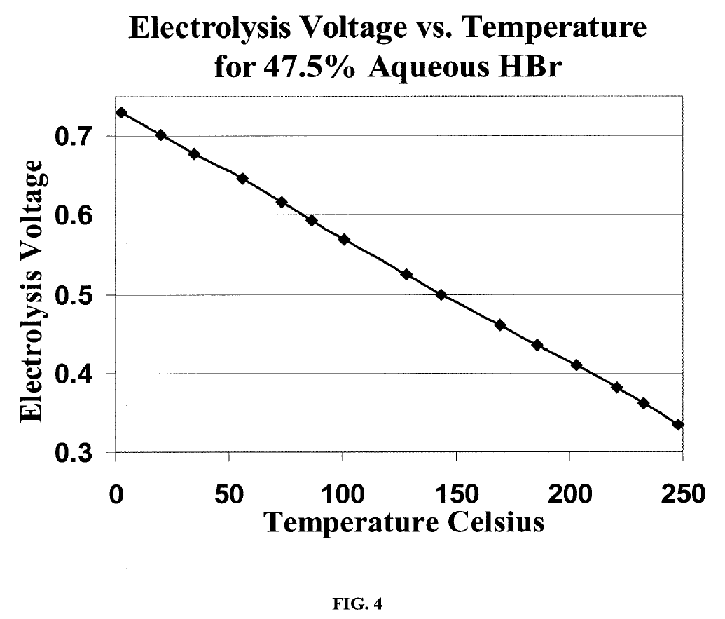

In another embodiment of the invention, the HBr solution is electrolyzed at high temperature to regenerate bromine and produce hydrogen using less energy than HBr electrolysis at room temperature and other prior art methods. The electrolysis of HBr benefits greatly with increased temperature. FIG. 4 illustrates how the electrolysis voltage for a 47.5% by weight HBr azeotrope in water decreases from 0.7 Volts at 25° C. to 0.4 Volts at 200° C., corresponding to 8.4-4.8 kWh/lbH₂, in accordance with an embodiment of the invention. Lower electrolysis energies have been demonstrated. For comparison, water electrolysis requires 24 kWh/lbH₂ when performed at 2 Volts. The bromination process is exothermic and its heat of reaction may be used to reduce the electricity required for hydrogen production by maintaining a high HBr electrolysis temperature.

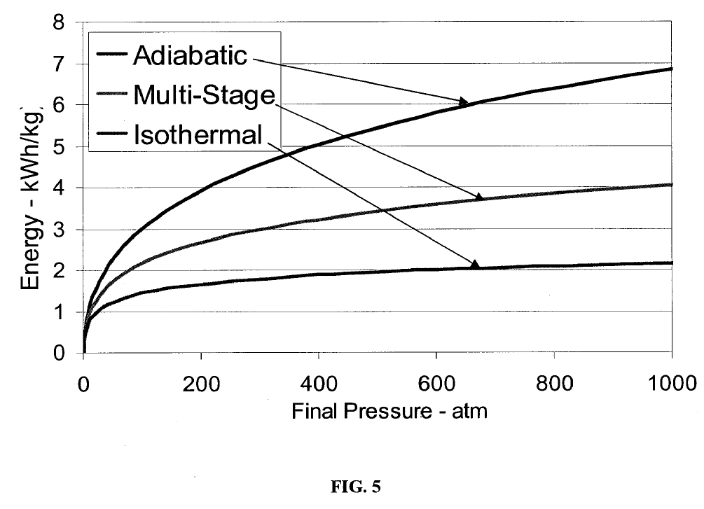

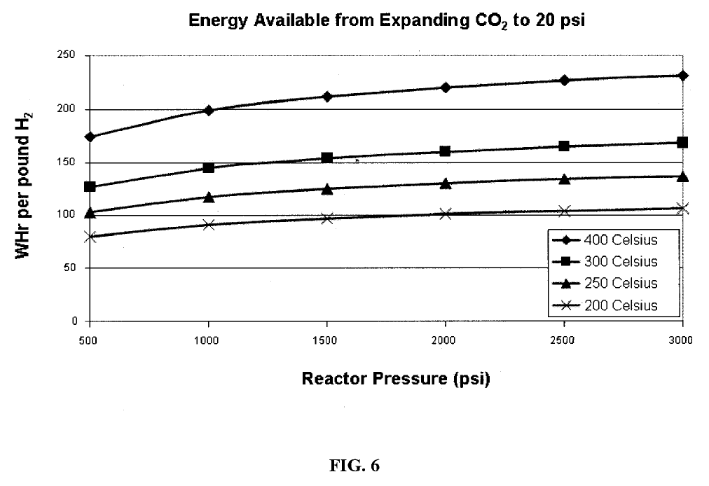

In another embodiment of the invention, if the reactor and electrolyzer are operated at high pressure, hydrogen produced at a high pressure does not need to be compressed as much (or at all) before further use (e.g., sale, storage, or consumption). Delivering hydrogen at 200 atm (about 3000 psi) saves 2½kWhr per kilogram of hydrogen. FIG. 5 is a plot showing the energy required to compress hydrogen as a function of pressure (“final pressure” as illustrated), in accordance to an embodiment of the invention. The adiabatic (top line) and isothermal (bottom line) plots represent limiting cases, whereas multi-stage (middle line) plot is typically achieved in practice.

In another embodiment of the invention, CO₂ and/or other gases (N₂, HBr, H₂O) generated in the reactor may be expanded through a prime mover (e.g., a turbine, motor, turbine and generator, compressor, or an equivalent) to produce power. FIG. 6 illustrates the power produced from expanding CO₂ to 20 psi from a given initial reactor pressure and temperature, in accordance with an embodiment. HBr and water vapors, present alongside the CO₂, would increase the energy produced by about 50% when the reactor is at 225° C. Increasing reactor temperature and producing a lower concentration HBr solution could further increase the amount of energy generated. The energy produced (or released) from expanding the CO₂ can be at least about 5%, or at least about 10%, or at least about 15% or at least about 30%, or at least about 50% of the electrolysis energy required. The energy released can vary depending on reactor and exiting conditions.

### Halogenation Reactor

In another aspect of the invention, reactors (also “reaction vessels” or “chambers” herein) configured for halogenation and electrolysis are provided. Reactors of embodiments of the invention can be configured for bromination, iodization, chlorination or fluoridation of one or more carbon-containing species. In preferable embodiments of the invention, a first halogen-containing chemical, a carbon-containing material and water are added to the reactor. The carbon-containing material may include certain quantity of a sulfur-containing chemical, such as, e.g., elemental sulfur, SO₂ or H₂SO₄. In some embodiments of the invention, a sulfur-containing chemical (e.g., elemental sulfur or sulfuric acid) can be added to the reactor. The first halogen-containing chemical is disassociated into a second halogen-containing chemical and hydrogen gas, which are removed from the reactor. In an embodiment of the invention, the first halogen-containing chemical is electrolyzed into the second halogen-containing chemical and hydrogen gas. The second halogen-containing chemical reacts with the carbon-containing material to yield, among other things, carbon dioxide, water and a third halogen-containing chemical. In an embodiment of the invention, the third halogen-containing chemical is equivalent to the first halogen-containing chemical. In a preferable embodiment of the invention, the first halogen-containing chemical is HBr, the second halogen-containing chemical is Br₂ and the third halogen-containing chemical is HBr.

In an embodiment of the invention, a mixture of reactants, including a carbon-containing material, HBr, water and a sulfur-containing chemical, is added to the reactor. HBr is disassociated into H₂ and Br₂. Br₂ reacts with the carbon-containing material to yield water, CO₂ and HBr. CO₂ released during reaction can be directed through a prime mover (e.g., turbine) to generate energy. HBr is recovered via one or more vapor phase recovery apparatuses, such as, e.g. one or more scrubbers.

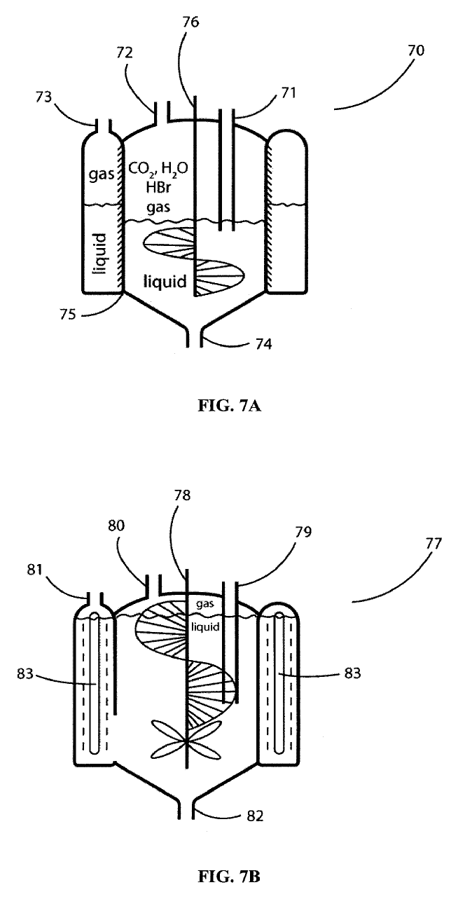

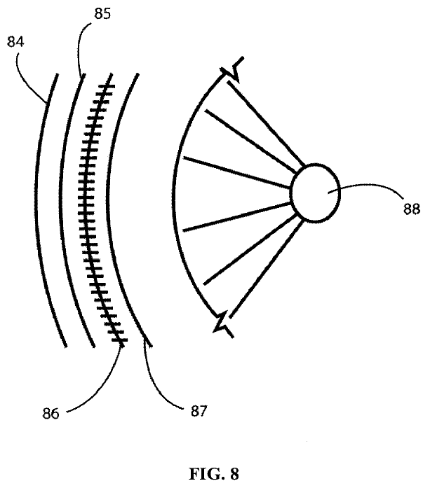

With reference to FIG. 7A, a reactor 70 configured for halogenation (e.g., bromination) and electrolysis of one or more reactants is shown. The reactor 70 includes a reactant inlet port 71 for introducing reactants into the reactor 70; a first outlet port 72 for removing product gases from the reactor 70; a second outlet port 73 for removing sulfur and carbon-containing material (e.g., ash) from the reactor 70; a third outlet port 74 for removing hydrogen gas (H₂) from the reactor 70; and a mixing member (or mixer) 76. The reactor 70 further includes a proton (or cation) exchange membrane (PEM) 75. The PEM 75 separates reactants and products from H₂ that is evolved during reaction. The PEM 75 can separate protons from ionic fragments of a halogen-containing chemical, such as a bromine-containing chemical (HBr). For example, the PEM 75 can facilitate the separation of H+ and Br− upon dissociation of HBr in solution and in the presence of energy. The PEM 75 can facilitate the gas-phase electrolysis of hydrogen bromide. As illustrated, the liquid levels may vary on either side of the PEM 75.

The reactor can be a dual or combined halogenation reactor and electrolyzer. In an embodiment of the invention, the reactor 70 can be a fuel cell. In another embodiment of the invention, the reactor 70 can be a reversible fuel cell.

With continued reference to FIG. 7A, the reactor 70 enables halogenation and electrolysis to occur in a single, insulated vessel or reactor. The reactor 70 may be a high-pressure vessel. A feedstock of reactants (also “feedstock” herein), including a carbon-containing material, a first halogen-containing chemical (e.g., Br₂) and water, is added to the reactor 70, where the carbon-containing material is halogenated (e.g., brominated) to produce a second halogen-containing chemical (e.g., HBr) and carbon dioxide (CO₂). In some cases carbon monoxide may be formed in place of or in addition to CO₂. In some embodiments of the invention, a sulfur-containing chemical (e.g., elemental sulfur, SO₂, H₂SO₄) can be provided to the reactor 70 with the feedstock. However, in some cases the feedstock may include sulfur, in which case additional sulfur may not be required. Alternatively, sulfur or other sulfur compounds (e.g. H₂S) may be added, which in the presence of a halogen-containing chemical (such as, e.g., Br₂) and water can form sulfuric acid. Solid ash, including insoluble metal sulfates, can be removed from the bottom of the reactor or filtered from solution; they may undergo further processing to remove any halogen-containing chemicals in (or included in or associated with) the solid ash.

In a preferable embodiment of the invention, in the reactor 70 hydrobromic acid (HBr) is decomposed (or dissociated) into ionic fragments (e.g., H+ and Br−), which combine to form bromine (Br₂) and hydrogen (H₂). In an embodiment of the invention, Br₂ and H₂ are in gaseous (or vapor) form. While a PEM 75 is used in the reactor 70, the decomposition and/or separation of ionic fragments of HBr may be facilitated using other means, such as, e.g., a metal bed or ceramic membrane.

With continued reference to FIG. 7A, the mixer 76 can stir and agitate reactants to ensure thorough mixing to facilitate the reaction. The mixer 76 can have a large surface area and intimate contact with the reacting solution, in which case the mixer 76 may serve as the anode. The solution itself may serve as a slurry electrode with or without the addition of additional conducting material to facilitate the movement of electrons from bromide ions for combination with protons to produce hydrogen at the cathode. In a preferable embodiment, the reactor 70 allows halogenation (e.g., bromination) and electrolysis to occur at elevated temperatures and pressures, reducing the energy needed for both electrolysis and hydrogen compression while improving the halogenation of a carbon-containing material.

FIG. 7B illustrates a reactor 77 having a mixing member (“mixer”) 78, a reactant inlet port 79, a first outlet port 80, a hydrogen gas (H₂) outlet port 81, a second outlet port 82, and cathodes 83. In the illustrated embodiment, the cathodes 81 are disposed behind a physical barrier to capture H₂ evolved during reaction and separate H₂ from other gases in the reactor 77. This barrier may be porous to allow the reactants to contact the cathodes 83; it could have greater porosity near the bottom of the reactor 77.

With continued reference to FIG. 7B, reactants, including a carbon-containing material, a halogen-containing material (e.g., HBr) and a sulfur-containing material (e.g., S or H₂SO₄), are provided to the reactor 77 via the reactant inlet 79. Gaseous products (or byproducts) can be removed from the first outlet port 80 and the hydrogen gas outlet port 81. Solid products, including dense sulfur-containing chemicals, can be removed from the second outlet port 82. As illustrated, ash and sulfates can be removed from the reactor 77 via the second outlet port 82.

With reference to FIG. 8, a halogenation reactor, such as any one of the halogenation reactors of FIGS. 7A and 7B, can include an insulated wall 84 to reduce heat losses; a wall 85 (such as a high pressure wall) to contain reactants; a cathode 86; a PEM (or porous physical barrier) 87; and a central mixer 88. The central mixer 88 can also be an anode of such a reactor. The cathode 86 can have a large surface area to permit sufficient contact between a halogen-containing chemical (e.g., HBr) and the cathode 86.

In another aspect of the invention, an energy production system comprises a reactor configured for reacting a carbon-containing material and a first halogen-containing chemical to form a second halogen-containing chemical and carbon dioxide. In some embodiments, the reactor is further configured for dissociating the first halogen-containing chemical into the second halogen-containing chemical and hydrogen gas (H₂). In embodiments of the invention, the reactor is a combination of a halogenation reactor and electrolyzer. In some cases the reactor can be reversible fuel cell. The energy production system can further comprise a primer mover for generating energy from one or both of H₂ and CO₂.

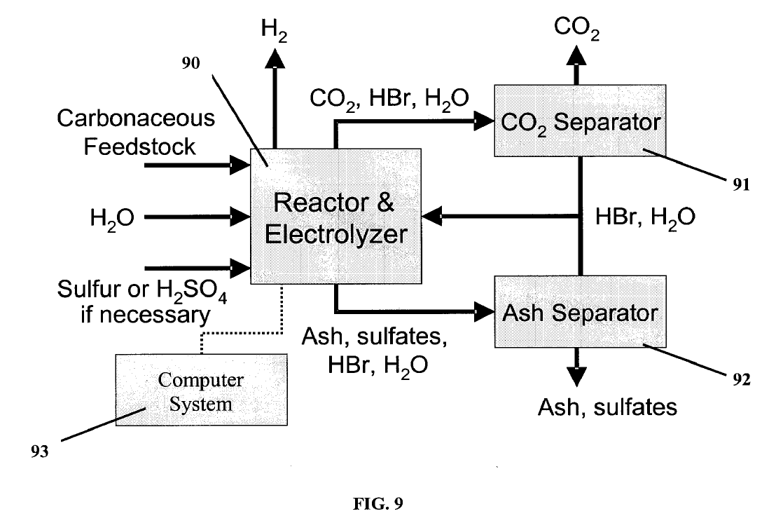

In some embodiments of the invention, the energy production system can include a computer system (such as the computer system 93 of FIG. 9) configured to control various reactions and process parameters. For example, the computer system can maintain the temperature of the reactor at an optimum level. As another example, the computer system can control the flow rate of a carbon-containing material (or carbon-containing chemical) into the reactor. As another example, the computer system can control the mode (i.e., electrolyzer or fuel cell) in which a reversible fuel cell is operated in. For instance, in off-peak operation the computer system can operate the reversible fuel cell as an electrolyzer, and in on-peak operation the computer system can operate the reversible fuel cell as a fuel cell. The computer system can maintain the temperature and pressure of a reactor (e.g., halogenation reactor, combined halogenation and electrolysis reactor, reversible fuel cell, or fuel cell) within predetermined levels. In an embodiment of the invention, the computer system maintains the temperature of the reactor between about 1° C. and about 500° C., or between about 100° C. and about 400° C., or between about 200° C. and about 350° C. In another embodiment of the invention, the computer system maintains the pressure of the reactor between about 1 atm and about 500 atm, or between about 15 atm and about 400 atm, or between about 150 atm and 300 atm, or between about 1 atm and 15 atm.

FIG. 9 shows an energy and/or fuel production system (also “system” herein) having a reactor 90 (also “reactor-electrolyzer” herein) configured for bromination and electrolysis, in accordance with an embodiment of the invention. Carbon-containing material, HBr and water are directed into the reactor 90. To reduce the loss of HBr, a sulfur-containing chemical can be added to the reactor 90, which reacts with metal halides in the reactor 90 to form metal sulfates and HBr. The sulfur-containing chemical can be sulfuric acid, elemental sulfur (S) or a sulfur oxide, such as SO₂.

With continued reference to FIG. 9, the electrolysis of HBr produces Br₂ and H₂, which leaves the reactor through an exhaust port to the reactor 90. Br₂ can be used for the bromination of the carbon-containing chemical in the reactor 90 to produce CO₂. Next, CO₂ and HBr are directed from the reactor 90 into a gas separator (“CO₂ Separator,” as illustrated) 91.

With continued reference to FIG. 9, upstream of the reactor 90 (i.e., between the reactor 90 and the gas separator 91, or after the gas separator 91) the system may include additional units. For example, the system may include a prime mover (e.g., turbine) to extract energy from high-pressure gas directed out of the reactor. The system might also include a flash tank; a settling tank; a hydrocyclone; a gravity separating device; a demister or water scrubber to remove and capture the HBr; and/or another device or combination of devices to separate HBr, such as, e.g., a zeolite. The gas separator separates CO₂ and HBr. At least a portion of the HBr can be returned (or recycled) to the reactor 90. Any carbon-containing chemical (e.g., ash) and sulfur-containing chemical (e.g., H₂SO₄, S) sulfates are removed from the reactor 90 and delivered to an ash separator 92. Here, devices such as centrifuges, flash tanks, boilers and filters may be employed to remove the ash, metal sulfates and any unreacted carbon for disposal or reuse, while the HBr and water are returned to the reactor 90. The system further includes a computer system 93 configured to, e.g., maintain the temperature and the pressure of the reactor 90. The computer system 93 can also control various parameters (e.g., temperatures, pressures, flow rates) of the gas separator 91 and the ash separator 92.

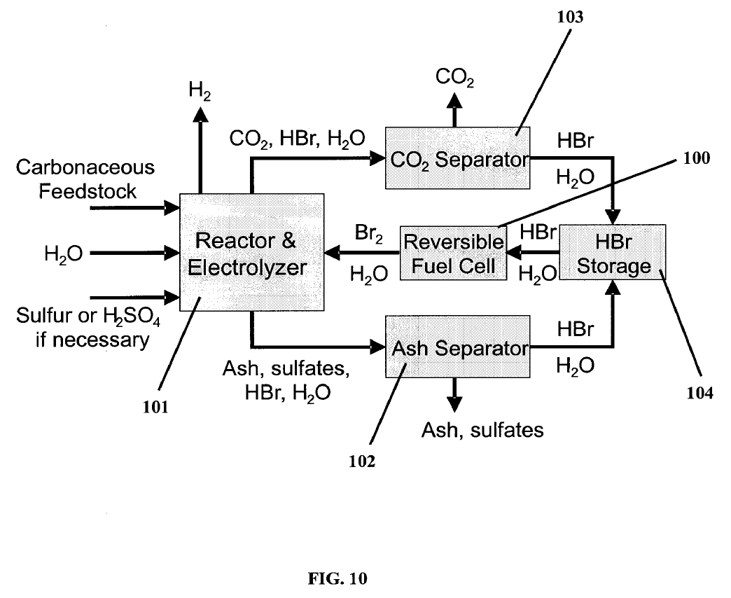

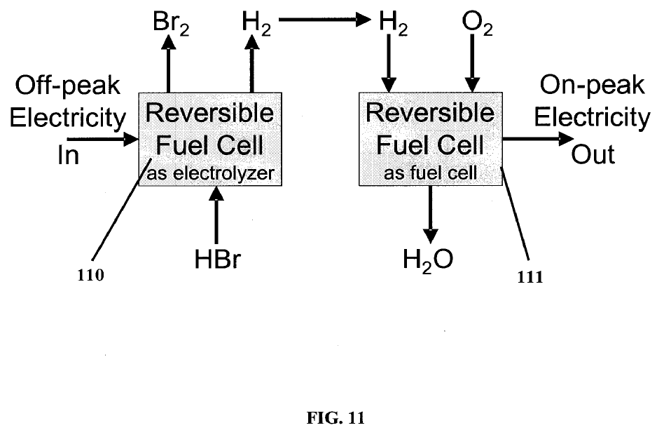

With reference to FIG. 10, the system of FIG. 9 can include an electrolyzer 100. HBr collected from CO₂ and ash-separating equipment can be sent to the electrolyzer 100 (“reversible fuel cell” as illustrated). The electrolyzer 100 could function as a reversible fuel cell, allowing HBr to be electrolyzed into Br₂ and H₂. Alternatively, if operated in fuel cell mode, the electrolyzer 100 could be used to produce electricity. If operated as a reversible fuel cell, Br₂ from the electrolyzer 100 is directed into a reactor 101. Carbon-containing material, water and a sulfur-containing chemical are added to the reactor 101. Any ash and sulfates collected in the reactor 101 can be directed to an ash separator 102. Any CO₂ formed during reaction can be directed to a CO₂ separator 103 to separate the CO₂ from HBr and any H₂O that may be present. HBr obtained from the CO₂ separator can be stored in an HBr storage unit 104.

While the systems of FIGS. 9 and 10 have been shown to use HBr, it will be appreciated that other halogen-containing chemicals can be used. For example, HCl or HI can be used in the systems of FIGS. 9 and 10. Further, while the systems of FIGS. 9 and 10 each include a single reactor, it will be appreciated that a plurality of reactors can be used. For example, the system of FIG. 10 can include 2, 3, 4, 5, 6, 7, 8, 9, or 10 reactors in series, parallel, or a combination of series and parallel configurations. While the electrolyzer 100 of FIG. 10, as illustrated, is a reversible fuel cell, it will be appreciated that any other unit configured for dissociating HBr into Br₂ and H₂ can be used.

### Reversible Fuel Cell

In some embodiments, hydrogen can be reacted with a halogen-containing chemical (e.g., Br₂, Cl₂, I₂), oxygen or air in a fuel cell to generate electrical power. In an embodiment of the invention, the same system or reactor that electrolyzes hydrogen bromide to produce hydrogen may be designed to react the hydrogen with oxygen to produce electricity, possibly more electricity than required for the hydrogen's generation from hydrogen bromide.

With reference to FIG. 11, hydrogen produced from hydrogen bromide electrolysis may be reacted with oxygen in a separate system (e.g., a fuel cell or a combustion turbine) or within the same electrolyzer used to generate Br₂ to produce power. During “off-peak” operation, a reversible fuel cell 110 may be operated as an electrolyzer to electrolyze HBr into Br₂ and H₂. In such a case, electricity may be directed into the reversible fuel cell 110. During “on-peak” operation, a reversible fuel cell 111 can be operated as a fuel cell to react (or combust) H₂ and O₂ (or Br₂), thereby producing energy. In such a case, electricity may be provided by the reversible fuel cell 111. It will be appreciated that the reversible fuel cells 110 and 111 can be the same fuel cell. The reversible fuel cell in such a case can be operated as either an electrolyzer if electricity is provided to electrolyze HBr, or as a fuel cell if H₂ is combusted to produce electricity.

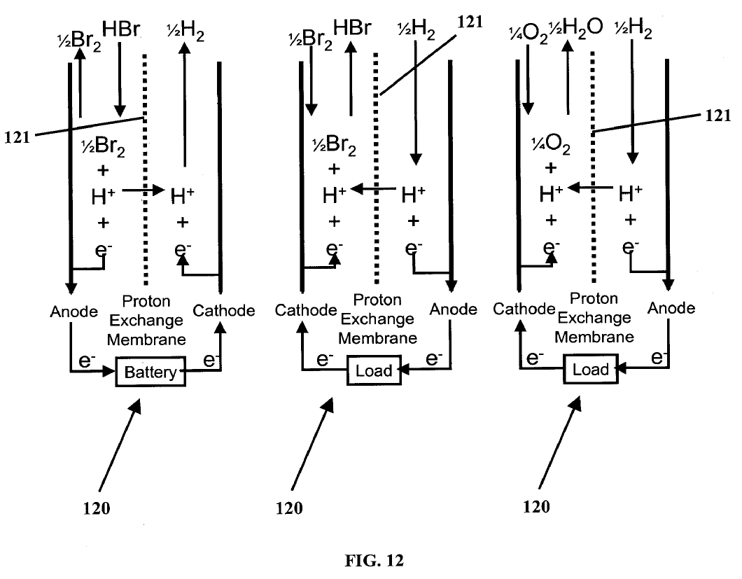

FIG. 12 shows a method by which a reversible fuel cell could operate to both electrolyze hydrogen bromide and react hydrogen with oxygen (or Br₂) in a fuel cell to generate electricity. In the illustrated embodiment, a reversible fuel cell 120 is configured to operate with multiple oxidizers. A proton exchange membrane (PEM) 121 separates protons (H+) from Br₂ once HBr is dissociated. The cathode and anode have been illustrated. When the reversible fuel cell 120 is operated as an electrolyzer, electricity can be provided by a battery (or any other source of electricity). When the reversible fuel cell 120 is operated as a fuel cell, a “load” provides for an electromotive force to promote a flow of electrons. Electricity generated in such a case can be stored or directed to a power grid.

With continued reference to FIG. 12, the reversible fuel cell 120 can operate as an electrolyzer to consume electricity to regenerate reactants or as a fuel cell to produce electricity by consuming reactants. When the reversible fuel cell 120 is used as an electrolyzer, HBr is provided to the reversible fuel cell 120, where it can be electrolyzed to produce hydrogen and bromine gas (Br₂). The reversible fuel call 120 can then be flushed to remove any remaining HBr. When the reversible fuel cell 120 is operated as a fuel cell, H₂ and O₂ (or air) can be provided to the reversible fuel cell 120, where they react to produce water and electricity. Alternatively, when the reversible fuel cell 120 is operated as a fuel cell, H₂ and Br₂ can be provided to the reversible fuel cell 120, where they react to produce HBr and electricity. Such a system advantageously utilizes the same capital equipment and has the potential to produce more electricity in fuel cell mode with hydrogen and oxygen than needed for hydrogen bromide electrolysis.

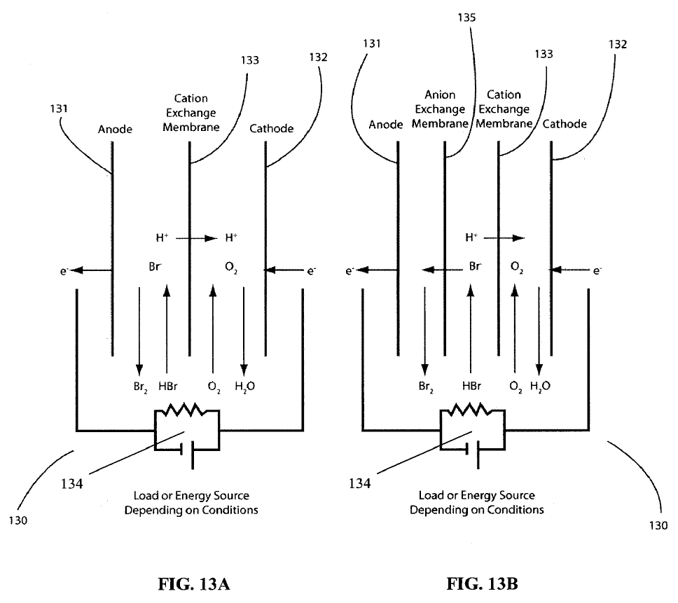

An electrolyzer may include a stack of alternating plates to provide for the control of reactant and product flows, current collection and distribution, cation and/or anion exchange membranes, and insulation. FIG. 13A shows a reversible fuel cell 130 having plates configured to allow a hydrogen-oxygen reaction to generate electrical energy following hydrogen bromide (HBr) electrolysis, according an embodiment of the invention. The reversible fuel cell 130 comprises a stack of plates (“stack”), including an anode 131, a cathode 132, a cation (or proton) exchange membrane 133 and a load/energy source 134. If the reversible fuel cell 130 is operated as an electrolyzer, the load/energy source 134 provides electrical energy to promote the dissociation of HBr into H₂ and Br₂. If the reversible fuel cell 130 is operated as a fuel cell, the load/energy source 134 provides a load to promote an electromotive force. With reference to FIG. 13B, in an alternate configuration, the reversible fuel cell 130 can include an anion exchange membrane 135. The cation exchange membrane 133 and the anion exchange membrane 135 promote the separation of H+ and Br− ions once they are dissociated from HBr with the aid of electrical energy.

With continued reference to FIGS. 13A and 13B, the reversible fuel cell 130 can reduce or eliminate the energy needed to regenerate bromine; it simplifies the system by eliminating the need to handle hydrogen outside of the electrolyzer-fuel cell (also “reversible fuel cell” herein) stack. The stacks can rely solely on a cation exchange membrane to separate oxidation and reduction zones; both an anion and cation membrane for the separation; or solely an anion membrane (not pictured).

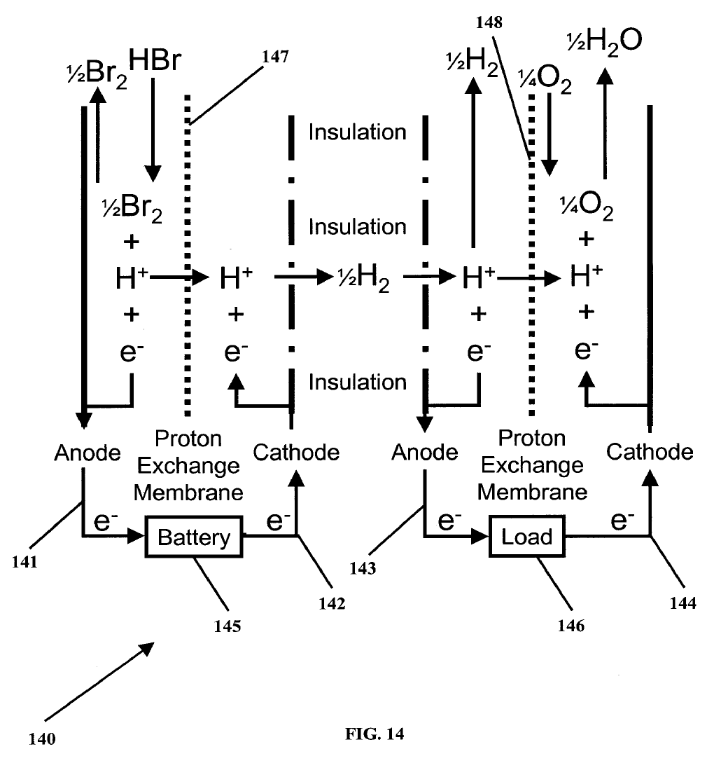

The reversible fuel cell 130 of FIGS. 13A and 13B could also separate the electrolysis and fuel cell modes into two separate membrane assemblies that could be placed next to each other and insulated from each other, as shown in FIG. 14. FIG. 14 shows a reactor 140 comprising an first anode 141, a first cathode 142, a second anode 143, a second cathode 144, a battery (or any other source of electricity) 145, a load 146 for promoting the flow of electrons, a first proton exchange membrane (PEM) 147 and a second PEM 148. The reactor 140 can also include one or more anion exchange membranes in addition to one or both of the first PEM 147 and the second PEM 148. The reactor 140 provides for further isolating the different membranes with their specialized functions, while simplifying and reducing or eliminating the handling of hydrogen (H₂) outside of the electrolyzer-fuel cell stack.

All reactors (e.g., reversible fuels cells, electrolyzers, fuel cells) described above may contain a variety of catalyst materials (e.g., platinum, ruthenium, rhodium, palladium, osmium, iridium, gold, silver, nickel, copper and other rare earth elements and combinations thereof) with compositions ranging from several nanograms/m³ to pure catalyst material. The structural supports may be made up of a range of materials, including, e.g., carbon, graphite, plastics, metals, inorganic and organic materials. In an embodiment of the invention, a reversible fuel cell apparatus comprises a plastic structure flow control for promoting the flow of one or more reactants (e.g., HBr or H₂ and O₂/Br₂), a graphite carbon Toray paper as the anode material, and a catalyst-doped graphite carbon Toray paper as the cathode material.

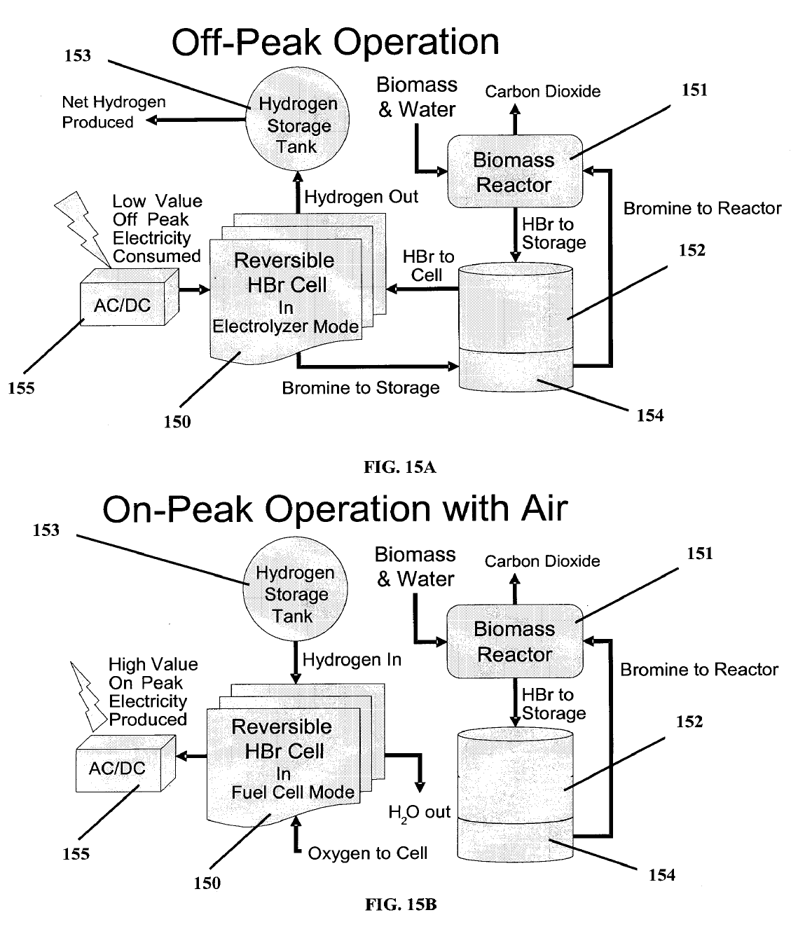

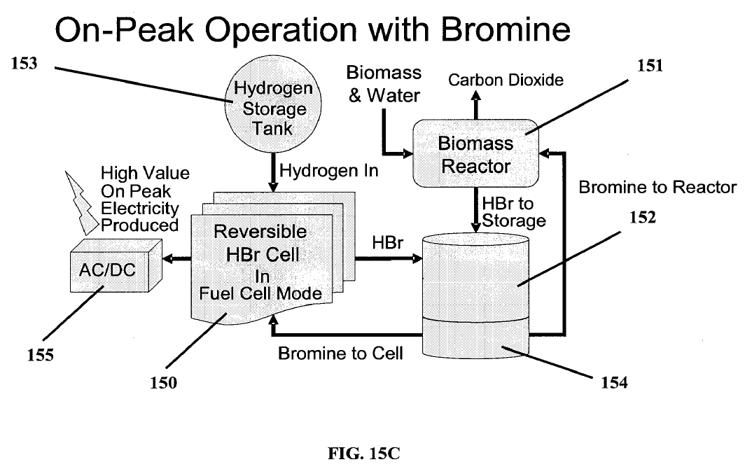

FIGS. 15A-15C illustrate a reversible fuel cell 150 and an independent biomass reactor 151, which are utilized to generate hydrogen through HBr electrolysis, to provide power by reacting hydrogen (H₂) with oxygen (O₂) or bromine (Br₂). Reactants and produces provided to each of the units have been illustrated. Biomass, which includes one or more carbon-containing materials, is directed into the biomass reactor 151. The biomass may include a sulfur-containing chemical, such as, e.g., elemental sulfur, SOₓ, or H₂SO₄. In the biomass reactor 151, the carbon-containing material can be reacted with Br₂ and H₂O to yield HBr, CO₂ and energy (see above). HBr can subsequently be stored in a hydrogen bromide storage tank 152. In the reversible fuel cell, HBr is dissociated into H₂ and Br₂. H₂ produced in the reversible fuel cell 150 can be stored in a hydrogen storage tank 153; Br₂ produced in the reversible fuel call 150 can be stored in a bromine storage tank 154. While the HBr tank 152 and the bromine tank 154 have been illustrated as a single unit, it will be appreciated that they can be separate units. An AC/DC convertor 155 provides electric power when the reversible fuel cell 150 is operated as an electrolyzer. The AC/DC convertor 155 can be used to direct electricity out of the reversible fuel cell 150 when the reversible fuel cell 150 is used as a fuel cell to produce electricity.

With continued reference to FIGS. 15A-15C, electrolysis could occur during inexpensive “off-peak” periods (FIG. 15A), such as at night when demand (and the price of electricity) is low, while fuel cell operation could occur during “on-peak” periods (FIGS. 15B and 15C), such as during the day when demand (and the price of electricity) is high. Such a system could continually generate HBr through the bromination of biomass, or other HBr-containing feedstock materials not limited to biomass, such as, e.g., sulfur-containing compounds. As described previously, the biomass reactor could also function as an electrolyzer to produce hydrogen.

### NOx Control

In some embodiments of the invention, methods for removing a nitrogen-containing chemical, such as, e.g., NOₓ (e.g., NO, NO₂, N₂O₃, N₂O₄, N₂O₅, N₂O, HNO₂ and HNO₃), from exhaust waste gas streams and, more specifically, coal-fired power plant flue gases, are provided. In an embodiment of the invention, a process chemically similar to the ISPRA Mark 13a process for controlling sulfur dioxide power plant emissions is provided, wherein:

SO₂(g)+Br₂(l)+2H₂O(l)→H₂SO₄(l)+2HBr(aq) (51)

ΔH°=−188kJ/mole ΔG°=−123kJ/mole (52)

SO₂(g)+Br₂(aq)+2H₂O(l)→H₂SO₄(aq)+2HBr(aq) (53)

ΔH°=−281kJ/mole ΔG°=−182kJ/mole (54)

Nitrogen oxide species are reacted with a solution of bromine and water to form nitric and hydrobromic acid:

NO(g)+1.5Br₂(aq)+2H₂O(l)→HNO₃(aq)+3HBr(aq) (55)

ΔH°=−88kJ/mole ΔG°=−43kJ/mole (56)

NO₂(g)+½Br₂(aq)+H₂O(l)→HNO₃(aq)+HBr(aq) (57)

ΔH°=−75kJ/mole ΔG°=−32kJ/mole (58)

N₂O(g)+4Br₂(aq)+5H₂O(l)→2HNO₃(aq)+8HBr(aq) (59)

ΔH°=−29kJ/mole ΔG°=12kJ/mole (60)

N₂O₃(g)+2Br₂(aq)+3H₂O(l)→2HNO₃(aq)+4HBr(aq) (61)

ΔH°=−29kJ/mole ΔG°=12kJ/mole (62)

N₂O₄(g)+Br₂(aq)+2H₂O(l)→2HNO₃(aq)+2HBr(aq) (63)

ΔH°=−29kJ/mole ΔG°=12kJ/mole (64)

N₂O₅(g)+H₂O(l)→2HNO₃(aq) (65)

ΔH°=−29kJ/mole ΔG°=12kJ/mole (66)

The following reactions are also relevant to the reduction (or oxidation of species comprising NO and NO₂.

NO(g)+½Br₂(aq)+H₂O(l)→HNO₂(aq)+HBr(aq) (67)

ΔH°=exothermic (68)

HNO₂(aq)+½O₂(g)→HNO₃(aq) (69)

ΔH°=exothermic (70)

HNO₂(aq)+Br₂(aq)→BrNO₂(aq)+HBr(aq) (71)

ΔH°=exothermic (72)

BrNO₂(aq)+H₂O(l)→HNO₃(aq)+HBr(aq) (73)

ΔH°=exothermic (74)

HNO₂(aq)+Br₂(aq)+H₂O(l)→HNO₃(aq)+2HBr(aq) (75)

ΔH°=exothermic (76)

With reference to reaction (67), bromine oxidizes nitrogen oxide (NO) to nitric acid (HNO₂) and HBr in a thermodynamically favorable (exothermic) reaction. HBr formed during reaction is directed to an electrolyzer (also “electrolysis cell” here), where the HBr is electrolyzed to produce H₂ and bromine (Br₂), which can be recycled to react with NO per reaction (67) above:

2HBr(aq)→H₂(g)+Br₂(aq) ΔH°=240kJ/mole ΔG°=212kJ/mole (77)

HBr may also be reacted in an alternate process, such as, e.g., reacted with a metal bed (or catalytic bed) to obtain hydrogen, or burned with oxygen to recover bromine.

A portion of the spent scrubbing solution can be continually removed, and its nitric acid content can be concentrated and stored. Both hydrogen (H₂) and nitric acid may be sold, consumed internally, or used to make other chemical products, including alternative liquid fuels, which can be used to generate electricity in an environmentally friendly fashion. If reacted with oxygen, hydrogen releases more energy than needed to electrolyze HBr:

H₂(g)+½O₂(g)→H₂O(g) ΔH°=−242kJ/mole ΔG°=−229kJ/mole (78)

Not only are emissions of the polluting oxides of nitrogen controlled, but renewable hydrogen is produced from their conversion to marketable nitric acid.

In some embodiments of the invention, the NOx reactants can be converted to molecular nitrogen. This conversion may be dependent on reaction conditions, such as, e.g., temperature and pressure.

### Mercury Control

In some embodiments of the invention, methods for removing mercury from exhaust waste gas streams, such as from coal-fired power plant (also “coal power plant” herein) flue gas streams, are provided. In an embodiment of the invention, a process captures mercury and mercuric oxide emissions, and converts them into mercuric bromide via exothermic reactions, as shown in Table 9:

TABLE 9

| | ΔH° | ΔG° |
|---|---|---|
| Mercury Reactions | (kJ/mole) | (kJ/mole) |
| Hg(g) + Br₂(aq) → HgBr₂(s) | −229 | −189 |
| Hg(l) + Br₂(aq) → HgBr₂(s) | −168 | −157 |
| 2Hg(g) + Br₂(aq) → Hg₂Br₂(s) | −327 | −249 |
| 2Hg(l) + Br₂(aq) → Hg₂Br₂(s) | −204 | −185 |
| HgO(s) + Br₂(aq) → HgBr₂(s) + ½O₂(g) | −77 | −99 |
| 2HgO(s) + Br₂(aq) → Hg₂Br₂(s) + O₂(g) | −23 | −68 |
| ½Hg₂(g) + Br₂(aq) → HgBr₂(s) | −223 | −191 |
| Hg₂(g) + Br₂(aq) → Hg₂Br₂(s) | −313 | −253 |

Mercuric bromide salt can precipitate out of solution or react with sulfuric acid in solution to form mercuric sulfate, which can precipitate out of solution or filtered out of solution. The relatively small amount of precipitate (about 115 lbs/year Hg equivalent from a 300 MW coal plant) can be collected in a reactor, pre-concentrator or final concentrator, or any other device configured for precipitate removal (or capture), and be disposed of or treated to regenerate elemental mercury.

### Hazardous Air Pollutants (HAPs) Control

In some embodiments of the invention, methods for removing HAPs from exhaust waste gas streams, such as from coal-fired power plant flue gas streams, are provided. In an embodiment of the invention, an aqueous solution of bromine is used to capture Hazardous Air Pollutants (HAPs). The strong oxidizing properties of bromine can facilitate the capture of HAPs. Table 10 provides reactions between some HAPs and an aqueous bromine solution:

TABLE 10

| | ΔH° | ΔG° |
|---|---|---|
| Representative HAP Reaction | (kJ/mole) | (kJ/mole) |
| Arsenic Compounds | | |
| AsH₃(s) + 3Br₂(aq) → AsBr₃(c) + 3HBr(aq) | −621 | −642 |
| AsH₃(s) + 3Br₂(aq) → AsBr₃(g) + 3HBr(aq) | −553 | −552 |
| As(s) + 1.5Br₂(aq) → AsBr₃(s) | −194 | −255 |
| As(g) + 1.5Br₂(aq) → AsBr₃(s) | −496 | −516 |
| As(g) + 1.5Br₂(aq) → AsBr₃(g) | −429 | −426 |
| Cesium Compounds | | |
| Cs(s) + Br₂(aq) → CsBr(s) | −403 | −395 |
| Cs(g) + Br₂(aq) → CsBr(s) | −480 | −445 |
| Antimony Compounds | | |
| Sb(s) + 1.5Br₂(aq) → SbBr₃(s) | −256 | −245 |
| Sb(s) + 1.5Br₂(aq) → SbBr₃(g) | −191 | −230 |
| Beryllium Compounds | | |
| Be(s) + Br₂(aq) → BeBr₂(s) | −351 | |
| Be(g) + Br₂(aq) → BeBr₂(s) | −675 | |
| Cadmium Compounds | | |
| Cd(s) + Br₂(aq) → CdBr₂(s) | −314 | −300 |
| Cd(g) + Br₂(aq) → CdBr₂(s) | −425 | −378 |
| Cd(s) + Br₂(aq) → CdBr₂(aq) | −316 | −289 |
| Cd(g) + Br₂(aq) → CdBr₂(aq) | −428 | −367 |
| Cd(s) + Br₂(aq) + 4H₂O(l) → | −347 | −304 |
| CdBr₂*4H₂O(s) | | |
| Cd(g) + Br₂(aq) + 4H₂O(l) → | −459 | −381 |
| CdBr₂*4H₂O(s) | | |
| Lead Compounds | | |
| Pb(s) + Br₂(aq) → PbBr₂(s) | −276 | −266 |
| Pb(g) + Br₂(aq) → PbBr₂(s) | −471 | −428 |
| Nickel Compounds | | |
| Ni(s) + Br₂(aq) → NiBr₂(s) | −210 | |
| Ni(g) + Br₂(aq) → NiBr₂(s) | −639 | |
| Selenium Compounds | | |
| Se(s) + Br₂(aq) → SeBr₂(g) | −18 | |
| Se(g) + Br₂(aq) → SeBr₂(g) | −246 | |
| Manganese Compounds | | |
| Mn(s) + Br₂(aq) → MnBr₂(s) | −382 | |
| Mn(g) + Br₂(aq) → MnBr₂(s) | −663 | |
| Barium Compounds | | |
| Ba(s) + Br₂(aq) → BaBr₂(s) | −755 | −741 |
| Ba(g) + Br₂(aq) → BaBr₂(s) | −935 | −887 |
| Chromium Compounds | | |
| Cr(s) + Br₂(aq) → CrBr₂(s) | −300 | |
| Cr(g) + Br₂(aq) → CrBr₂(s) | −696 | |
| Cobalt Compounds | | |
| Co(s) + Br₂(aq) → CoBr₂(s) | −218 | |
| Co(g) + Br₂(aq) → CoBr₂(s) | −643 | |
| Copper Compounds | | |
| Cu(s) + ½Br₂(aq) → CuBr(s) | −103 | |
| Cu(g) + ½Br₂(aq) → CuBr(s) | −441 | |
| Cu(s) + Br₂(aq) → CuBr₂(s) | −139 | |
| Cu(g) + Br₂(aq) → CuBr₂(s) | −477 | |
| Silver Compounds | | |
| Ag(s) + ½Br₂(aq) → AgBr(s) | −99 | −99 |
| Ag(g) + ½Br₂(aq) → AgBr(s) | −384 | −345 |
| Vanadium Compounds | | |
| V(s) + 2Br₂(aq) → VBr₄(s) | −332 | |
| V(g) + 2Br₂(aq) → VBr₄(s) | −846 | |
| Titanium Compounds | | |
| Ti(s) + Br₂(aq) → TiBr₂(s) | −399 | |
| Ti(g) + Br₂(aq) → TiBr₂(s) | −872 | |
| Ti(s) + 1.5Br₂(aq) → TiBr₃(s) | −545 | −530 |
| Ti(g) + 1.5Br₂(aq) → TiBr₃(s) | −1018 | −958 |
| Ti(s) + 2Br₂(aq) → TiBr₄(s) | −612 | −597 |
| Ti(g) + 2Br₂(aq) → TiBr₄(s) | −1085 | −1026 |
| Zinc Compounds | | |
| Zn(s) + Br₂(aq) → ZnBr₂(s) | | |
| Zn(g) + Br₂(aq) → ZnBr₂(s) | | |

In an embodiment of the invention, most of the bromide salts formed can precipitate out of solution or react with sulfuric acid in solution to form sulfates, which can precipitate out of solution in the reactor where they can be collected with the mercuric bromide or mercuric sulfate for disposal or treatment. Following reaction, some HAP species may remain in solution as a soluble ash; these compounds may be removed with sulfuric acid, which is already in solution from the SOₓ control reaction discussed above, or can be added to form metal sulfates. These sulfate compounds can precipitate out of solution in the reactor, or can be removed with lime by forming metal hydroxides. Filters, centrifuges and boilers may be used to separate hydroxide, bromide and sulfate species.

It will be appreciated that the reactions and processed discussed above can be applied to other HAPs not mentioned. It will be appreciated that there may be other feasible reactions with bromine to capture and react with the HAPs, sometimes with the aid of water. Hazardous air pollutants bromine can react or interact with include, without limitation: Acetaldehyde, Acetamide, Acetonitrile, Acetophenone, 2-Acetylaminofluorene, Acrolein, Acrylamide, Acrylic acid, Acrylonitrile, Allyl chloride, 4-Aminobiphenyl, Aniline, o-Anisidine, Asbestos, Benzene, Benzidine, Benzotrichloride, Benzyl chloride, Biphenyl, 3,3-Dimethoxybenzidinem Bis(chloromethyl)ether, Bromoform, 1,3-Butadiene, Calcium cyanamide, Caprolactam, Captan, Carbaryl, Carbon disulfide, Carbon tetrachloride, Carbonyl sulfide, Catechol, Chloramben, Chlordane, Chlorine, Chloroacetic acid, 2-Chloroacetophenone, Chlorobenzene, Chlorobenzilate, Chloroform, Chloromethyl methyl ether, Chloroprene, Cresols/Cresylic acid, o-Cresol, m-Cresol, p-Cresol, Cumene, 2,4-D, salts and esters, DDE, Diazomethane, Dibenzofurans, 1,2-Dibromo-3-chloropropane, Dibutylphthalate, 1,4-Dichlorobenzene(p), 3,3-Dichlorobenzidene, Dichloroethyl ether, 1,3-Dichloropropene, Dichlorvos, Diethanolamine, N,N-Dimethylaniline, Diethyl sulfate, Naphthalene, Bis(2-ethylhexyl)phthalate (DEHP), Dimethyl aminoazobenzene, 3,3′-Dimethyl benzidine, Dimethyl carbamoyl chloride, Dimethyl formamide, 1,1-Dimethyl hydrazine, Dimethyl phthalate, Dimethyl sulfate, 4,6-Dinitro-o-cresol, and salts 2,4-Dinitrophenol, 2,4-Dinitrotoluene, 1,4-Dioxane (1,4-Diethyleneoxide), 1,2-Diphenylhydrazine, Epichlorohydrin (1-Chloro-2,3-epoxypropane), 1,2-Epoxybutane, Ethyl acrylate, Ethyl benzenz, Ethyl carbamate (Urethane), Ethyl chloride (Chloroethane), Ethylene dibromide (Dibromoethane), Ethylene dichloride (1,2-Dichloroethane), Ethylene glycol, Ethylene imine (Aziridine), Ethylene oxide, Ethylene thiourea, Ethylidene dichloride (1,1-Dichloroethane), Formaldehyde, Heptachlor, Hexachlorobenzene, Hexachlorobutadiene, Hexachlorocyclopentadiene, Hexachloroethane, Hexamethylene-1,6-diisocyanate, Hexamethylphosphoramide, Hexane, Hydrazine, Hydrochloric acid, Hydrogen fluoride (Hydrofluoric acid), Hydrogen sulfide (See Modification), Hydroquinone, Isophorone, Lindane (all isomers), Maleic anhydride, Methanol, Methoxychlor, Methyl bromide (Bromomethane), Methyl chloride (Chloromethane), Methyl chloroform (1,1,1-Trichloroethane), Methyl ethyl ketone (2-Butanone), Methyl hydrazine, Methyl iodide (Iodomethane), Methyl isobutyl ketone (Hexone), Methyl isocyanate, Methyl methacrylate, Methyl tert butyl ether, 4,4-Methylene bis(2-chloroaniline), Methylene chloride (Dichloromethane), Methylene diphenyl diisocyanate (MDI), 4,4-Methylenedianiline, Nitrobenzene, 4-Nitrobiphenyl, 4-Nitrophenol, 2-Nitropropane, N-Nitroso-N-methylurea, N-Nitrosodimethylamine, N-Nitrosomorpholine, Parathion, Pentachloronitrobenzene (Quintobenzene), Pentachlorophenol, Phenol, p-Phenylenediamine, Phosgene, Phosphine, Phosphorus, Phthalic anhydride, Polychlorinated biphenyls (Aroclors), 1,3-Propane sultone, beta-Propiolactone, Propionaldehyde, Propoxur (Baygon), Propylene dichloride (1,2-Dichloropropane), Propylene oxide, 1,2-Propylenimine(2-Methyl aziridine), Quinoline, Quinone, Styrene, Styrene oxide, 2,3,7,8-Tetrachlorodibenzo-p-dioxin, 1,1,2,2-Tetrachloroethane, Tetrachloroethylene (Perchloroethylene), Titanium tetrachloride, Toluene, 2,4-Toluene diamine, 2,4-Toluene diisocyanate, o-Toluidine, Toxaphene (chlorinated camphene), 1,2,4-Trichlorobenzene, 1,1,2-Trichloroethane, Trichloroethylene, 2,4,5-Trichlorophenol, 2,4,6-Trichlorophenol, Triethylamine, Trifluralin, 2,2,4-Trimethylpentane, Vinyl acetate, Vinyl bromide, Vinyl chloride, Vinylidene chloride (1,1-Dichloroethylene), Xylenes (isomers and mixture), o-Xylenes, m-Xylenes, p-Xylenes, Coke Oven Emissions, Cyanide Compounds1, Glycol ethers2, Fine mineral fibers3, Polycylic Organic Matter4 and Radionuclides (including radon)5.

### Particulate Matter (PM) Control

In other embodiments of the invention, methods for removing PM from exhaust waste gas streams, such as from coal-fired power plant flue gas streams, are provided. Particulate matter includes, without limitation, particles of carbon, silica and alumina having various particle sizes (or diameters), such as, e.g., on the order of several nanometers or micrometers (“microns”). In some cases, these particles may be sufficiently small to behave as gases. In an embodiment of the invention, an aqueous, preferably dilute bromine water solution can be contacted with flue gas to capture particulate emissions. The contacted solution may contain nitric acid, sulfuric acid, hydrobromic acid (HBr) and other chemical species. The particulate matter may be captured using a scrubber. The scrubbing solution can be an all-fluid mixture, which allows it to be pumped and sprayed through smaller diameter nozzles. This results in smaller drop sizes, which increases the surface area (or contact area) of spray for a given recirculation volume and increases the likelihood of contacting PM in the flue gas. Conventional emission control processes utilize slurries of solids in water, which require a larger minimum spray nozzle size to avoid clogging, and are therefore unable to remove significant particulate matter.

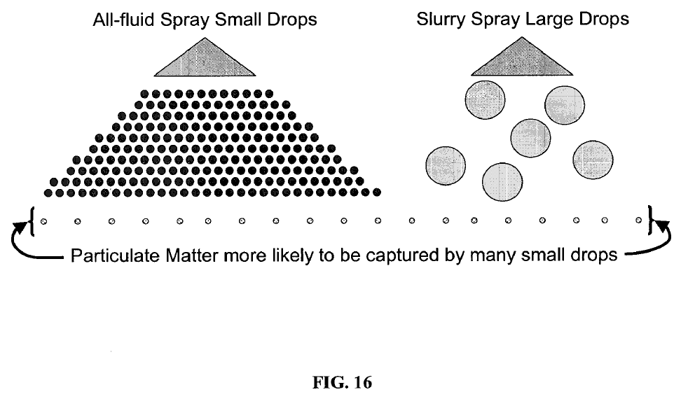

In FIG. 16, a plurality of small drops (left) can offer improved particulate matter capture efficiencies when compared to larger drops (right), which are typically provided using a sprayed slurry having larger drops. The small drops collectively offer a larger surface area than the large drops. In an embodiment of the invention, when an all-fluid scrubbing solution is used, smaller drops can be formed.

### Hydrogen Sulfide (H₂S) Control

In other embodiments of the invention, methods for removing H₂S from gas streams, such as sour well-head gas, refinery waste streams, anaerobic digesters, coal-bed methane, and coal-fired power plant flue gas streams as found in coal gasification plants, are provided. In an embodiment of the invention, hydrogen sulfide species are reacted with a solution of bromine and water to form sulfuric acid (H₂SO₄) and hydrobromic acid (HBr):

H₂S(g)+4Br₂(l)+4H₂O(l)→H₂SO₄(l)+8HBr(aq) (79)

ΔH°=−622kJ/mole ΔG°=−540kJ/mole (80)

H₂S(g)+4Br₂(aq)+4H₂O(l)→H₂SO₄(aq)+8HBr(aq) (81)

ΔH°=−707kJ/mole ΔG°=−610kJ/mole (82)

Bromine oxidizes the sulfide species to sulfuric acid and forms hydrogen bromide (HBr). Reactions (79) and (81) are exothermic. HBr can then be directed to an electrolysis cell (e.g., a reversible fuel cell), where the HBr is electrolyzed to produce hydrogen (H₂) and bromine (Br₂), which can be recycled to react with H₂S per reactions (79) and (81) above. One mole of H₂S can yield one mole of H₂ and one mole of H₂SO₄.

H₂S(g)+4H₂O(l)→H₂SO₄(aq)+4H₂(g) (83)

In this process, 8 pounds (“lb”) of hydrogen and 103 lb of sulfuric acid can be produced for every 32 lb of sulfur removed in H₂S. A portion of the spent scrubbing solution can be continually removed and its sulfuric acid content can be concentrated and stored. Both the hydrogen, which is renewable since it is produced from water, and the sulfuric acid, may be sold, consumed internally, or used to make other chemical products, including alternative liquid-fuels.

In another embodiment of the invention, methane can react with bromine and water in the following exothermic reaction:

CH₄(g)+4Br₂(aq)+2H₂O(l)→CO₂(g)+8HBr(aq) (84)

ΔH°=−709kJ/mole ΔG°=−716kJ/mole (85)

Methane's limited solubility allows it to pass through a dilute bromine-water solution without reacting with any of the species in solution as long as the temperature is kept between about 50° C. and about 400° C. H₂S is about a hundred times more soluble than methane; it reacts at lower temperatures. The reaction yield can be a function of temperature. A scrubbing apparatus may be used to increase the gas/liquid contact and accelerate the processes described above.

In another embodiment of the invention, hydrogen sulfide is reacted with bromine (Br₂), e.g., over a catalyst material (or catalyst bed) or under conditions suitable for sulfuric acid production (see above), to yield sulfur and hydrogen bromide:

H₂S(g)+Br₂(l)→S(s)+2HBr(g) (86)

ΔH°=−12.5kJ/mole ΔG°=−9.9kJ/mole (87)

H₂S(g)+Br₂(aq)→S(s)+2HBr(aq) (88)

ΔH°=−53.1kJ/mole ΔG°=−34kJ/mole (89)

### Removal of Phosphorus Compounds

In other embodiments of the invention, methods for removing a phosphorous-containing chemical, such as, e.g., phosphate, phosphorus, or organophosphorus compounds, from sewage plant and agricultural waste streams, are provided. In an embodiment of the invention, phosphorus is converted to phosphoric acid, which can be removed and used in, e.g., fertilizer. Exemplary exothermic reactions are as follows, wherein ‘R’ denotes a side group, such as, e.g., carbon:

P+2.5Br₂+4H₂O→H₃PO₄5HBr ΔG°=−34kJ/mole (90)

POR₃+1.5Br₂+3H₂O→H₃PO₄+3HBr+3R ΔG°=−34kJ/mole (91)

PO₂R₂+0.5Br₂+2H₂O→H₃PO₄+HBr+2R ΔG°=−34kJ/mole (92)

HPO₃R+H₂O→H₃PO₄+R(in the presence of halogen) ΔG°=−34kJ/mole (93)

In the reaction above, R may form a different compound during reaction. In some cases, R forms a different compound through reaction with water. For cases in which R is carbon, carbon is oxidized to carbon dioxide, as presented in other embodiments. It will be appreciated that the abovementioned reactions can occur in the liquid (e.g., aqueous solution) or gas phase.

In some embodiments of the invention, phosphorus is converted into other soluble or insoluble compounds, which may be incorporated into unreacted ash or converted into fertilizer.

### Removal of Waste Gases

In another aspect of the invention, devices, apparatuses and systems for removing waste gas are provided.

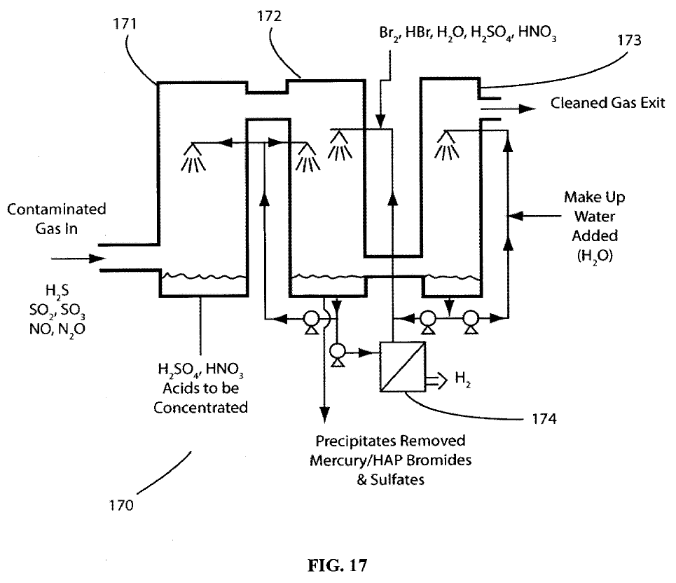

With reference to FIG. 17, a system 170 for capturing hydrogen sulfide (H₂S), SOx, NOx, mercury, HAP and/or PM is provided, in accordance with an embodiment of the invention. The system 170 comprises four main units. A first unit 171 (or first tower) is a concentrator where the products of reaction may be concentrated. The concentrated species can include one or more of HBr, elemental sulfur, sulfuric acid, nitric acid, H₂S, SO₂, SO₃, and NOx, HAP, PM and mercury. The solution at the bottom of the first unit could contain metal bromides and metal sulfates formed from mercury and HAP removal, in addition to PM. These may be separated for removal, treatment, and disposal. Acids directed into the first unit 171 can be concentrated. A vapor comprising contaminants (e.g., PM, HAP, H₂S) and HBr can be directed out of the first unit 171 and into a second unit (or second tower) 172. Before entering the second unit 172, the gas can be directed to a condenser-demister unit to remove HBr vapors, which may be placed in an aqueous HBr storage tank for electrolysis into hydrogen and bromine.

With continued reference to FIG. 17, the reactions discussed above (e.g., the reactions discussed in the context of PM control, HAP control, H₂S control, and removal of phosphorous compounds) can take place in the second unit 172. A gas to be “cleaned” is directed from the first unit 171 to the second unit 172. Here, the gas to be cleaned can be contacted with a solution containing bromine (Br₂) and water. The solution may also contain hydrogen bromide (HBr), sulfuric acid, and/or nitric acid. Upon reaction, precipitates comprising metal bromide and metal sulfate (formed from mercury, HAP, and/or PM) collect toward the bottom of the second unit 172. These may be “bled off” (i.e., removed in desired quantities) for removal, treatment, and disposal. After reacting with the bromine-water solution in the second unit 172, the gas is directed to a third unit 173, where it is contacted with a water solution to capture any hydrogen bromide or bromine vapors that may be in the gas. The vapors are dissolved in water and directed (e.g., using one or more pumps) to the second unit 172 for reaction and regeneration. The fluid at the bottom of the second unit 172 can be continuously bled off and fed to a fourth unit 174, an electrolyzer or any other bromine regenerator, to regenerate (or form) bromine (Br₂) and H₂. The bromine rich solution can then be directed into the second unit 172 to react with further contaminants.

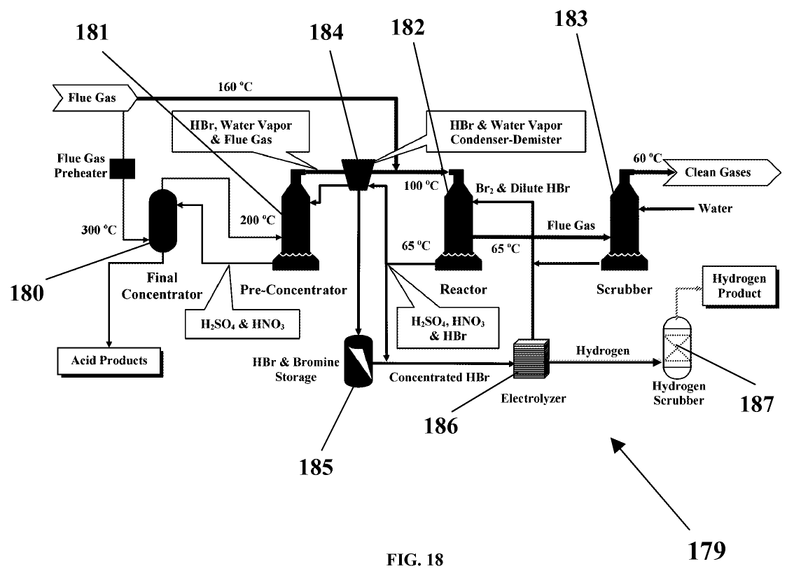

With reference to FIG. 18, in another embodiment of the invention, a system 179 for removing impurities (or contaminants) from a flue gas is provided. With reference to FIG. 18, hot incoming flue gas can be used to heat and concentrate acids in a final concentrator 180 and a pre-concentrator 181 before being directed to a reactor 182, where it is contacted with a bromine solution during a bromination reaction (see above). In a preferable embodiment of the invention, in the reactor 182 the flue gas is “cleaned” to form a gas that is scrubbed with water (or any other scrubbing solution) in a scrubber 183 to form cleaned flue gas (“clean gas” as illustrated). Exemplary temperatures of various streams into the illustrated units (or unit operations) of the system 179 are shown.

In an embodiment of the invention, the reactor 182 can be a co-current enclosed spray tower. The spraying liquid is an aqueous solution, containing about 15% HBr and about 1% bromine at a temperature of about 65° C. The bromine forms a complex with HBr, which makes it significantly less volatile before reaction. The liquid produced in the reactor 182, a bromine-free aqueous solution of about 10% sulfuric (H₂SO₄), 10% nitric (HNO₃) and 20% hydrobromic (HBr) acids, is sent to the pre-concentrator 181 via a condenser 184, where it is heated by incoming flue gas to evaporate the HBr vapors and most of the water. The pre-concentrator is a counter-current spray tower that outputs a solution of about 70% H₂SO₄ and HNO₃ to the final concentrator 180. In an embodiment of the invention, design temperatures are about 200° C. at the gas inlet to the pre-concentrator 181 and about 120° C. at the gas outlet of the pre-concentrator 181. The liquid leaving the pre-concentrator 181, a solution of about 70% H₂SO₄ and HNO₃, undergoes a final concentration step in the final concentrator 180, where about 93% sulfuric and 62% nitric acid solutions are produced. The final concentrator 180 can be a relatively small counter-current evaporator (or distillation) column where hot flue gases provide the necessary heat to concentrate and distill the H₂SO₄ and HNO₃. In an embodiment of the invention, the hot flue gases directed into the final concentrator 180 are at a temperature between about 100° C. and 500° C., or between about 200° C. and 400° C., or between about 250° C. and 350° C. In the illustrated embodiment of FIG. 18, the hot flue gases are at a temperature of about 300° C. At the above-mentioned concentrations, the mercuric bromide can form mercuric sulfate, precipitate from the acid, and be separated for disposal along with other impurities.

With continued reference to FIG. 18, HBr can be directed from the condenser 184 into an HBr and Br₂ storage tank 185. Next, HBr can be directed to an electrolyzer 186, where it is dissociated into H₂ and Br₂. H₂ formed in the electrolyzer 186 can be separated from Br₂ using an H₂ scrubber 187. Br₂ from the electrolyzer 186 can be directed into the reactor 182.

The HBr and water vapors boiled off in the pre-concentrator 181 are condensed into aqueous HBr in the condenser 184 and sent to the electrolyzer 186, which may include a stack of proton exchange membrane cells. The concentrated HBr electrolyte is split into hydrogen gas at a cathode and aqueous bromine at an anode of the electrolyzer 186. Process parameters, such as electrolyte flow and current density, are adjusted to control the quantity and concentration of bromine solution required for optimum emission control. In a preferable embodiment of the invention, the solution exiting the electrolyzer 186 is mixed with part of a final solution from the scrubber 183 to form dilute HBr and 1% (by weight) bromine oxidizing spray solution, which is directed into the reactor 182.

With continued reference to FIG. 18, a final spray (or washing) of the flue gas is achieved in the scrubber 183 to prevent bromine vapors from slipping to the environment in the outgoing flue gases. Water required for bromination reactions in the reactor 182 can be introduced here, which is purged to the spray solution directed into the reactor 182.

Integrating the Pre-Concentrator, Reactor and/or Scrubber into One Device

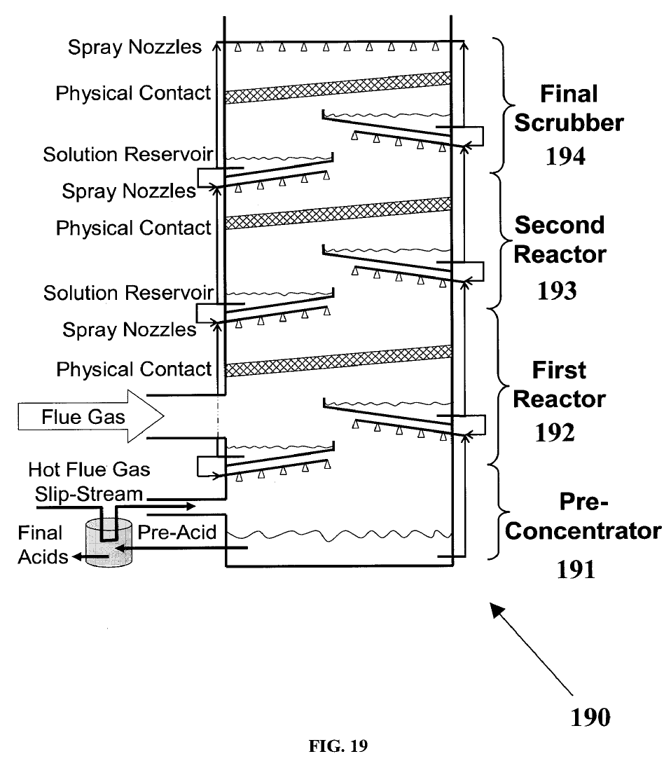

With reference to FIG. 19, in an embodiment of the invention, an apparatus (also “system” herein) 190 that integrates the pre-concentrator 181, reactor 182 and scrubber 183 of FIG. 18 in a single tower is shown. In a preferable embodiment of the invention, such the system 190 could simplify the interconnections between conventional towers; it could be constructed as a single unit with similar carbon or glass fiber reinforced plastics; it could benefit from cross current flow throughout the device; and it could benefit from significant economic and performance advantages. The system 190 can include a variety of devices, including physical contact surfaces, spray nozzles and reservoirs at different levels of the system 190 to separate one or more solutions in the system 190. A section for the final concentration of acids may be integrated into the system 190, which could provide HBr vapors and heat for the system 190.

With continued reference to FIG. 19, the system 190 comprises a pre-concentrator section 191, a first reactor section 192, a second reactor section 193 and a final scrubber section 194. Each of the sections 191, 192, 193 and 194 may include one more solution reservoirs and spray nozzles. In the illustrated embodiment, flue gas is directed into the system 190 at or near the first reactor section 192.

As an alternative, the spray nozzles and scrubber section 194 can be replaced with a scrubber that operates to form a froth zone of turbulent and intimate mixing between the flue gas and a scrubbing solution. Such intimate mixing increases the rate of reaction, the surface area of interaction and can serve to quench an incoming hot gas stream. Multiple sections (or stages) may be used in order to transition from a reactor to the scrubber so that both steps can be accomplished in the same vessel. The spray nozzle can have a large bore with less pressure drop than traditional small-bore spray nozzles.

### HBr Condenser-Demister

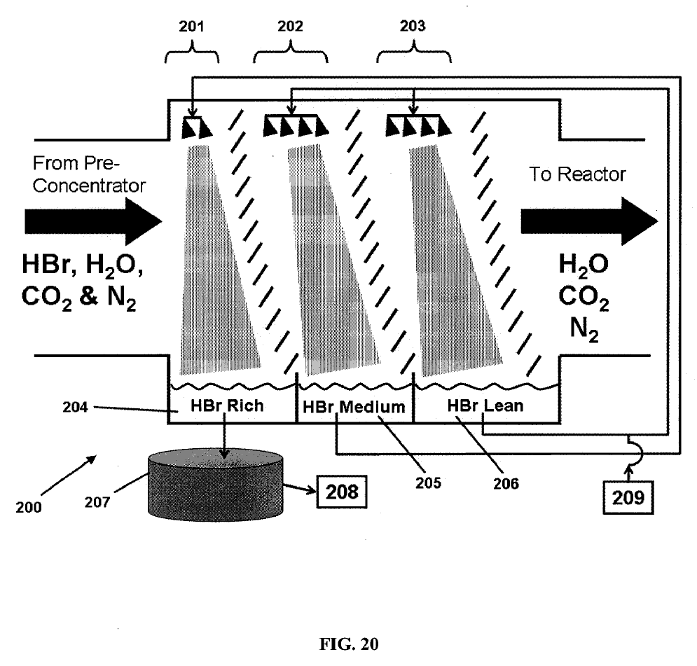

With reference to FIG. 20, in an embodiment of the invention, a device 200 that could be placed between the pre-concentrator 181 and reactor 192 of FIG. 18 is shown. This device 200 could function as a scrubber, condenser and demister to remove HBr vapors from the flue gas and into a concentrated solution. In the illustrated embodiment, flue gas from the pre-concentrator is contacted with a spray solution and a physical barrier, such as an open egg crate or chevron surface, in one or more stages. The device 200 comprises three physical contact regions and three spray regions: a first spray region 201, a second spray region 202 and a third spray region 203. The first spray region 201 can include a first collection pool 204; the second spray region 202 can include a second spray region 205; and the third spray region 203 can include a third collection pool 206, respectively. The concentration of HBr in the collection pools can decrease from the first collection pool 204 to the third collection pool 206. That is, the first collection pool 204 can have a high HBr concentration, the second collection pool 205 can have a medium HBr concentration, and the third collection pool 206 can have a low HBr concentration. HBr from the first collection pool 204 is directed to an HBr storage tank 207 and subsequently to an electrolyzer 208.

With continued reference to FIG. 20, in a preferable embodiment of the invention, a dilute HBr solution can be provided into the third spray region 203 from a scrubber 209, such as, e.g., scrubber 183 of FIG. 18. The dilute HBr solution can absorb HBr vapors. Some of this solution may become entrained in the gas and can be removed through impact with the contact surface, followed by condensation and recovery in a collection pool. The contact surfaces may also be designed as airfoils to induce pressure and velocity gradients that could also serve to remove and separate HBr and other species of interest from the gas they are entrained in. This solution is then sprayed through the second and third spray regions where it removes HBr vapors in the flue gas. Any entrained or evaporated droplets are captured and condensed on the physical surface and subsequently collected. The final result is a concentrated or pure aqueous HBr solution that can be stored prior to regeneration of H₂ and Br₂ (see above). While the device 200 comprises three spray regions, it will be appreciated that the device 200 can include more spray or fewer spray regions. For example, the device 200 can include one, two, or five spray regions. Additionally, in some cases the HBr rich collection pool may not be located in the first collection pool 204 but another collection pool. For example, the HBr rich collection pool may be located in the second collection pool 205, in which case HBr may be removed from the second collection pool 205 and directed to the electrolyzer 208.

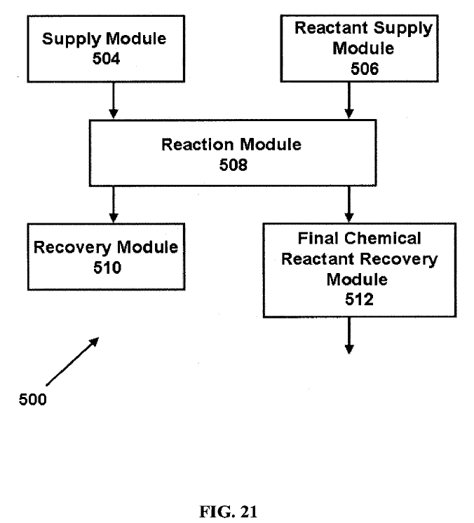

In another aspect of the invention, a system 500 for brominating reactants is provided. With reference to FIG. 21, the system 500 comprises a supply module 504, a reactant supply module 506, a reaction module 508, a recovery module 510, and a final chemical reactant recovery module 512. The bromine compound supply module 504 in various embodiments could supply bromine (e.g., bromine gas, Br₂ in solution), other bromine-containing chemicals (e.g., hydrogen bromide, hydrogen tribromide), other halogen-containing chemicals (e.g., HCl, HI, HF, Cl₂, I₂, F₂), or combinations of such chemicals to the reaction module 508. In embodiments of the invention, the reactant supply module 506 supplies carbon-containing material (e.g., coal, biomass, sewage, or an equivalent) or a gas (e.g., hydrogen sulfide, nitrogen oxides, sulfur oxides, mercury, or an equivalent with nitrogen, oxygen, and/or carbon dioxide) to the reaction module 508. The reaction module 508 can use various materials and conditions to optimize the chemical reaction. As an example, the bromination reaction chamber module 508 can use bromine resistant materials, an aqueous environment, and/or a high temperature environment. The recovery module 510 supplies, e.g., bromine or a brominated compound to the supply module 504 for reuse in the reaction module 508. In an embodiment of the invention, the recovery module 510 can include at least one electrolysis cell, where HBr is electrolyzed to produce H₂ and Br₂, which can be recycled for further reaction. The recovery module 510 can also include a metal bed, such as, e.g., a copper or silver bed. The final chemical reactant recovery module 512 receives the final reaction product from the reaction module 508 and removes the final reaction product (e.g., sulfuric acid, nitric acid, mercuric bromide, sulfur, ash, metal sulfates) for, e.g., commercial use, additional treatment, or disposal.

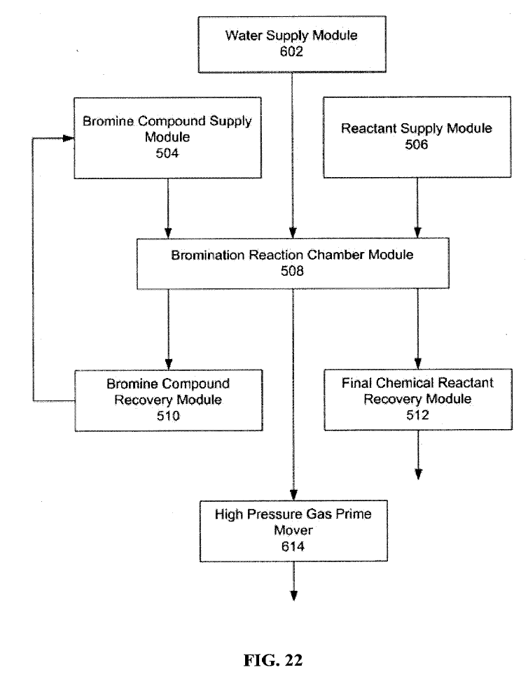

It will be appreciated that in the illustrated embodiment of FIG. 21 (as well as other embodiments of the invention, such as the illustrated embodiment of FIG. 22), one or more of the supply modules can include the following: coupling connections for hoses; pipes carrying gas, liquid, or solid ingredients; and one or more separate vessels, chambers, or modules coupled to the reaction module 508. It will be appreciated that reactant(s) can include coal, biomass, sewage, hydrogen sulfide, nitrogen oxides, mercury contaminated waste, sulfur oxides, nitrates, phosphates, phosphorus, petroleum coke, black liquor, pulp, or any other waste materials that can be utilized or more safely reacted.

FIG. 22 illustrates a system to brominate reactants and utilize high-pressure gas to operate a prime mover, in accordance with another embodiment of the invention. The system comprises a water supply module 602, a bromine compound supply module 504, a reactant supply module 506, a bromination reaction chamber module 508, a bromine compound recovery module 510, a final chemical reactant recovery module 512, and a high pressure gas prime mover 614. The bromine compound supply module 504 can supply a bromine-containing chemical, such as, e.g., Br₂ or HBr, to the bromination reaction chamber module 508. The reactant supply module 506 can supply a carbon-containing material, such as, e.g., coal, biomass, or milorganite, or a contaminant gas, such as, e.g., hydrogen sulfide, SO₂ or NOx, pulp, petroleum coke, or black liquor, to the bromination reaction chamber module 508. Various materials and reaction conditions can be used to optimize a chemical reaction in the bromination reaction chamber module 508. For example, a copper or silver bed or bromine resistant materials can be used in the reaction chamber module 508. As another example, an aqueous environment and/or a high temperature environment can be used in the reaction chamber module 508. The bromine compound recovery module 510 supplies bromine or a brominated compound to the bromine compound supply module 504 for reuse in the bromination reaction chamber module 508. The final chemical reactant recovery module 512 receives final reaction products from the bromination reaction chamber module 508 and removes the final reaction products for use or storage. The high-pressure gas prime mover 614 can be a turbine or a motor, or any electricity generator

In another aspect of the invention, methods for brominating reactants are provided. In embodiments of the invention, methods are provided for using a first halogen-containing chemical (e.g., Br₂) to halogenate (e.g., brominates, chlorinate) a contaminant, such as a carbon-containing chemical, H₂S, PM or a HAP, to form a second halogen-containing chemical (e.g., HBr).

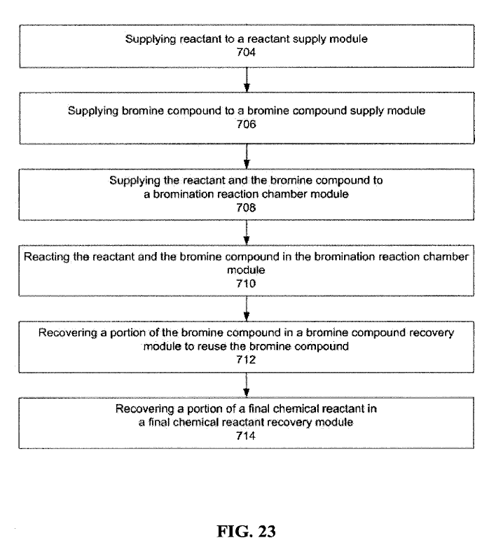

With reference to FIG. 23, a flowchart of a method to brominate reactants is provided, in accordance with an embodiment of the invention. First, reactants are supplied 704 to a reactant supply module. The reactants can include any material or chemical of embodiments of the invention, such as, e.g., a carbon-containing material (e.g., a carbonaceous material, such as biomass or swage), H₂S, HAP, PM, or NOx. Next, a bromine-containing chemical (“bromine compound” as illustrated) is supplied 706 to a bromine compound supply module. Next, the reactants and the bromine-containing chemical are supplied 708 to a bromination reaction chamber module. The reactants and the bromine-containing chemical are reacted 710 in bromination reaction chamber module. At least a portion of the bromine-containing chemical is recovered 712 in a bromine compound recovery module. Next, at least a portion of a final chemical reaction product is recovered 714 from the bromination reaction chamber module. The final chemical reaction product can include a sulfur-containing chemical, such as, e.g., elemental sulfur or H₂SO₄, ash, and/or metal sulfates.

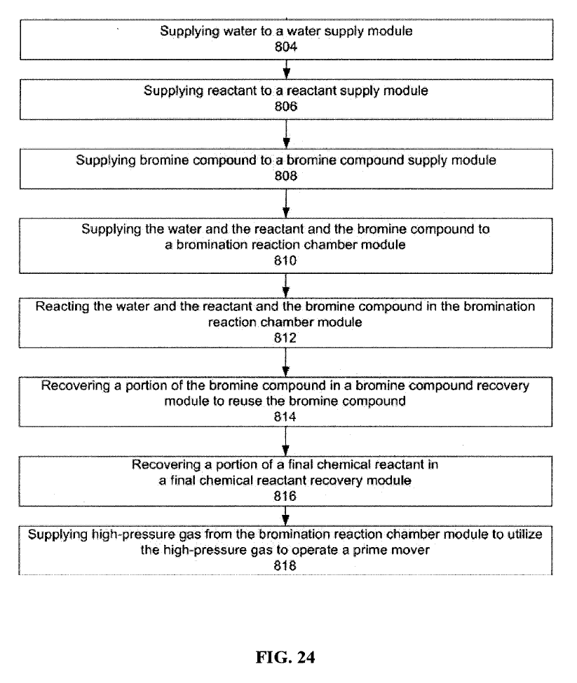

With reference to FIG. 24, a flowchart of a method to brominate reactants and utilize high pressure gas to operate a prime mover is provided, in accordance with an embodiment of the invention. First, water is supplied 804 to a water supply module. Next, one or more reactants (e.g., a carbon-containing chemical, H₂S, PM, HAP, NOx) are supplied 806 to a reactant supply module. Next, a bromine-containing chemical is supplied 808 to a bromine compound to a bromine compound supply module. Water, the one or more reactants, and the bromine-containing chemical (“bromine compound” as illustrated) are supplied 810 to a bromination reaction chamber module. Next, water, the one or more reactants and the bromine compound are reacted 812 in bromination reaction chamber module. At least a portion of the bromine compound is recovered 814 in a bromine compound recovery module. The recovered bromine compound can be reused for further reaction. Next, at least a portion of final chemical reaction products (e.g., one or more sulfur-containing chemicals, ash, metal sulfates) is recovered 816 from the bromination reaction chamber module. Next, high-pressure gas (e.g., high pressure CO2) is supplied 818 to a primer mover from the bromination reaction chamber module.

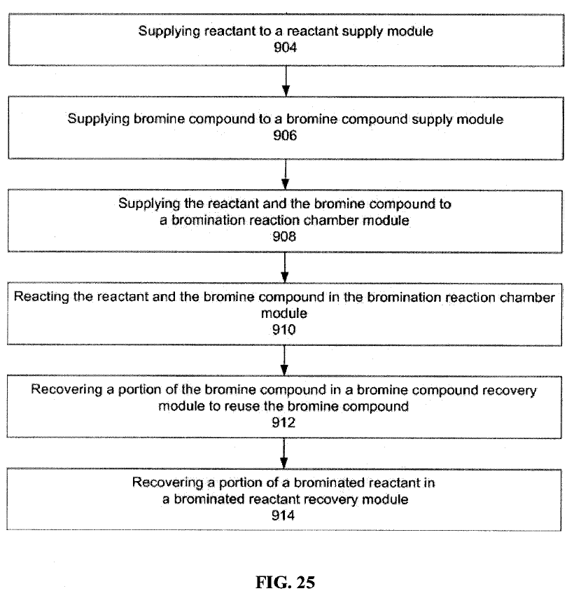

FIG. 25 illustrates a method to brominate reactants, in accordance with another embodiment of the invention. At step 904, one or more reactants are supplied to a reactant supply module. Next, a bromine-containing chemical (“bromine compound” as illustrated) are supplied 906 to a bromine compound supply module. Next, the reactant and the bromine compound are supplied 908 to a bromination reaction chamber module (also “bromination reactor” and “bromination reaction module” herein). The one or more reactants and the bromine compound are reacted 910 in the bromination reaction chamber module. Next, at least a portion of the bromine compound is recovered 912 in a bromine compound recovery module for optional reuse in the bromination reaction chamber module. Next, at least a portion of the brominated reactant is recovered 914 in a brominated reactant recovery module to remove the brominated reactant.

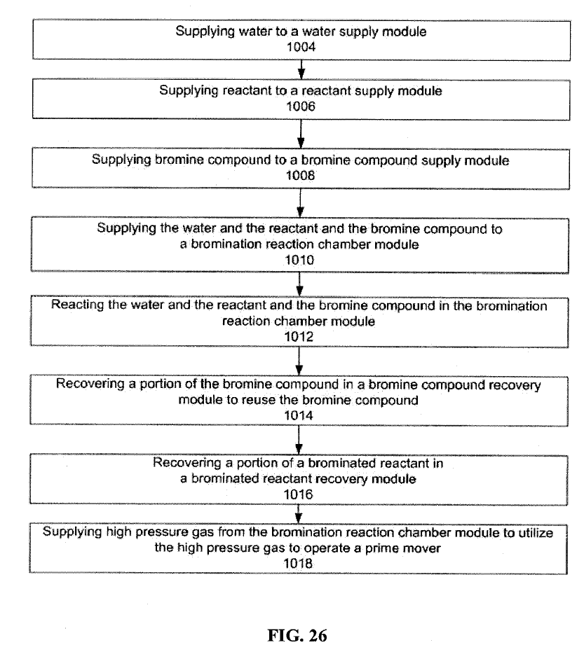

FIG. 26 illustrates a method for brominating reactants and utilizing high-pressure gas to operate a prime mover, in accordance with another embodiment of the invention. Water is supplied 1004 to a water supply module. Next, a reactant is supplied 1006 to a reactant supply module. A bromine-containing chemical (“bromine compound” as illustrated) is supplied 1008 to a bromine compound supply module. Water, the reactant and the bromine compound are supplied 1010 to a bromination reaction chamber module. Next, water, the reactant and the bromine compound are reacted 1012 in the bromination reaction chamber module. At least a portion of the bromine compound is recovered 1014 in a bromine compound recovery module for optional reuse in the bromination reaction chamber module. At least a portion of reaction products, which can include a brominated reactant, is recovered 1016 in a brominated reactant recovery module to remove any brominated reactant. High-pressure gas (e.g., CO₂) can be supplied 1018 from the bromination reaction chamber module to a prime mover to utilize the high-pressure gas to operate the prime mover.

### Use of Products

In an embodiment of the invention, electrolytic hydrogen generated from the processes described above may be used for generator cooling; hydrogen-enriched combustion to reduce nitrogen oxide emissions from natural gas combustion; the reduction of carbon monoxide or carbon dioxide to produce methanol and other higher carbon fuels (e.g., ethanol, propanol); and reaction with bromine, oxygen, or air in a fuel cell to generate electricity.

In some embodiments of the invention, hydrogen can be used to cool power plants. Its high heat capacity and low viscosity increases a generator's capacity by efficiently removing excess heat and reducing rotor windage losses. The processes described above produce high purity (i.e., electrolytic grade) hydrogen. A 4% increase in hydrogen purity allows an 800 MW generator to generate about 24 MW of additional electricity without any additional fuel requirement.

If an energy storage/black-start capability is desired, a reversible HBr stack (fuel cell) may be used in place of a dedicated electrolyzer, thereby enabling the production of electricity from the reaction of hydrogen with bromine (Br₂) or oxygen (O₂). For gas-fired boilers and turbines, hydrogen may be used to improve lean combustion stability limits and reduce the production of NOx. Natural gas enriched with 1% hydrogen can reduce NOx emissions by about 15%; translating to 0.8 kg reduction in NOx emissions for every kilogram of hydrogen. A 5% hydrogen/natural gas blend can reduce NOx by over 50%.

In addition, hydrogen may be combined with a plant's carbon dioxide emissions to produce methanol (CH₃OH), or with nitrogen to produce ammonia (NH₃), which may be used with selective catalytic reduction (SCR) or combined with CO₂ to produce urea, which can be used to reduce NOx in exhaust emissions. Ammonia can also be reacted with sulfuric acid (a by-product of certain reactions; see above for examples) to produce ammonium sulfate.

Sulfuric and nitric acids are prominent chemical commodities consumed globally. The yearly U.S. production of sulfuric acid and nitric acid are greater than 48 and 11 million tons, respectively. Some power plants may not have a convenient market for the acid by-products. In these cases, according to methods of preferable embodiments of the invention, the acid may be reacted with scrap iron or aluminum to produce ferrous sulfate or aluminum sulfate/nitrate, in addition to hydrogen. This reaction advantageously doubles the production of hydrogen and is cost effective because electrolysis (which is energy-intensive) is not used to generate hydrogen.

In other cases the sulfuric acid may be decomposed into sulfur dioxide (SO₂), water and oxygen. The purpose of such a process will be to convert the relatively inexpensive sulfuric acid into much more valuable sulfur dioxide, which could be used for alternative sulfur chemistries. These chemistries are understood and can be used in the pulp and paper, water treatment, tanning, food processing and other industries. Nitric acid may also be thermally decomposed for making other compounds or disposing of the acid.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of embodiments of the invention herein are not meant to be construed in a limiting sense. Furthermore, it shall be understood that all aspects of the invention are not limited to the specific depictions, configurations or relative proportions set forth herein which depend upon a variety of conditions and variables.

Various alternatives and modifications in form and detail of the embodiments of the invention will be apparent to a person skilled in the art. It is therefore contemplated that the invention shall also cover any such alternatives, modifications, variations and equivalents. For example, while certain embodiments provide methods and apparatuses for the using of HBr and Br₂, it will be appreciated that other halogen-containing species may be used. In some cases HCl and Cl₂ may be used instead of HBr and Br₂, respectively; or HF and F₂ may be used instead of HBr and Br₂, respectively; or HI and I₂ may be used instead of (or in place of) HBr and Br₂, respectively. As an example, a chlorine-containing compound (e.g., Cl₂) can be used in the process flow of FIG. 25. As another example, an iodine-containing compound (e.g., I₂) can be used in the process flow of FIG. 26. Further, while some reactors or reaction vessels have been referred to as “reversible fuel cells” (or “reversible fuel cell” individually) it t will be appreciated that such reactors or reaction vessels could be “fuel cells” (or “fuel cell” individually). Additionally, while systems of certain embodiments of the invention include a single reactor, it will be appreciated that such systems can include a plurality of reactors in series, parallel or a combination of series and parallel configurations. For example, the system of FIG. 10 can include 2, 3, 4, 5, 6, 7, 8, 9, or 10 reactors. While certain embodiments of the invention provide methods and systems for using a reversible fuel cell, it will be appreciated that any other unit configured for dissociating a first halogen-containing chemical (e.g., HBr, HCl, HI) into a second halogen-containing chemical (e.g., Br₂, Cl₂, I₂) and H₂ can be used.

We claim:

1. A method for generating energy and/or fuel from the halogenation of a carbon-containing material, comprising:
supplying the carbon-containing material and a first halogen-containing chemical to a reactor;
reacting the carbon-containing material and the halogen-containing chemical in the reactor to form a second halogen-containing chemical; and
dissociating the second halogen-containing chemical to form the first halogen-containing chemical and hydrogen gas (H₂).

2. The method of claim 1, wherein the first halogen-containing chemical is Br₂ and the second halogen-containing chemical is HBr.

3. The method of claim 1, wherein dissociating the second halogen-containing chemical comprises electrolyzing the second halogen-containing chemical.

4. The method of claim 1, wherein reacting the carbon-containing material and the halogen-containing chemical further comprises forming CO₂.

5. The method of claim 4, further comprising directing CO₂ to a prime mover.

6. The method of claim 1, wherein the carbon-containing material is biomass or sewage.

7. The method of claim 1, further comprising removing a sulfur-containing species from the reactor.

8. The method of claim 7, wherein the sulfur-containing species is selected from elemental sulfur and sulfuric acid.

9. The method of claim 1, further comprising supplying water to the reactor.

10. The method of claim 1, further comprising supplying a sulfur-containing chemical to the reactor.

11. The method of claim 10, wherein the sulfur-containing chemical includes one or more of H₂S, elemental sulfur, SO₂ and sulfuric acid.

12. A method for brominating a carbon-containing material, comprising:
supplying a carbon-containing material, Br₂ and H₂O to a reaction module;
reacting the carbon-containing material, Br₂ and H₂O to form HBr and CO₂; and
electrolyzing HBr into H₂ and Br₂.

13. The method of claim 12, wherein the carbon-containing chemical, Br₂ and H₂O are reacted at a temperature between about 1° C. and about 500° C.

14. The method of claim 12, wherein the carbon-containing chemical, Br₂ and H₂O are reacted at a pressure between about 1 atm and about 300 atm.

15. A method for cleaning a contaminated gas stream, comprising:
providing a contaminant in a reactor;
providing a first halogen-containing chemical in the reactor;
reacting the contaminant with the first halogen-containing chemical to form a second halogen-containing chemical; and
dissociating the second halogen-containing chemical to form the first halogen-containing chemical and hydrogen (H₂).

16. The method of claim 15, wherein the second halogen-containing chemical is dissociated in the reactor.

17. The method of claim 15, wherein the first halogen-containing chemical is selected from F₂, Cl₂, Br₂ and I₂.

18. The method of claim 15, wherein the second halogen-containing acid is selected from HF, HCl, HBr and HI.

19. The method of claim 15, wherein the contaminant includes one or more of a carbon-containing chemical, elemental sulfur, H₂S, SO₂, SO₃, NO, NO₂, N₂O and ash.

20. A halogenation reactor, comprising:
a first module configured for reacting a carbon-containing material and a first halogen-containing chemical to form a second halogen-containing chemical; and
a second module configured for dissociating the second halogen-containing chemical into the first halogen-containing chemical and hydrogen gas (H₂).

21. The halogenation reactor of claim 20, further comprising a proton exchange membrane for separating protons from ionic fragments of the second halogen-containing chemical.

22. The halogenation reactor of claim 20, wherein the first module and the second module are the same module.

23. The halogenation reactor of claim 20, wherein the second module is configured for reacting H₂ with O₂ to form water.

24. The halogenation reactor of claim 20, wherein the second module is configured for reacting H₂ with the first halogen-containing chemical to form the second halogen-containing chemical.

25. An energy production system, comprising:
a reversible fuel cell configured for reacting a carbon-containing material and a first halogen-containing chemical to form a second halogen-containing chemical and carbon dioxide, wherein the reversible fuel cell is further configured for dissociating the first halogen-containing chemical into the second halogen-containing chemical and hydrogen gas (H₂); and
a primer mover for generating energy from one or both of H₂ and CO₂.
